(19) United States
(12) Patent Application Publication
(10) Pub. No.: US 2023/0311069 A1
(43) Pub. Date: Oct. 5, 2023

(54) GREEN MEMBRANES FOR ORGANIC SOLVENT NANOFILTRATION AND PERVAPORATION

(71) Applicant: King Abdullah University of Science and Technology, Thuwal (SA)

(72) Inventors: Jamaliah H. ABURABIE, Zarqa (JO); Klaus-Viktor PEINEMANN, Thuwal (SA)

(21) Appl. No.: 18/119,461

(22) Filed: Mar. 9, 2023

Related U.S. Application Data
(63) Continuation of application No. 16/977,875, filed on Sep. 3, 2020, now abandoned.
(60) Provisional application No. 62/752,004, filed on Oct. 29, 2018.
(60) Provisional application No. 62/638,491, filed on Mar. 5, 2018.

(51) Int. Cl. B01D 67/00; B01D 61/02; B01D 61/36; B01D 69/02; B01D 69/12; B01D 71/08

(52) U.S. Cl. CPC B01D 67/0013; B01D 61/027; B01D 61/362; B01D 67/0006; B01D 69/02; B01D 69/125; B01D 71/08; B01D 2325/04; B01D 2325/20; B01D 2325/30

(57) ABSTRACT

Embodiments of the present disclosure describe thin-film composite membranes comprising a crosslinked alginate layer on a surface of a porous woven or non-woven support. Embodiments of the present disclosure further describe methods of preparing membranes, methods of manufacturing membranes, methods of separating chemical species, methods of using the membranes for organic solvent nanofiltration, pervaporation, and the like.

### BACKGROUND

Membranes-based separation is an attractive method compared to conventional processes (e.g. distillation and extraction), providing a smaller footprint, lower costs, and higher energy efficiency. The separation is based on concentration and pressure gradients across the membrane that occurs without phase transition.

Nanofiltration (NF) membranes have pore diameters in the range of 0.5 nm to 2 nm with a molecular weight cutoff (MWCO) of 200 g/mol to 2000 g/mol, which is generally the molecular weight at which 90% rejection is obtained. For organic solvent nanofiltration (OSN), the membranes must offer high chemical stability and attractive performance. Molecular separation with OSN is preferable because it is scalable and applicable for a wide variety of process conditions such as pH, temperature, solvent, and pressure. The role of OSN as a green technology, however, is limited by the waste generated during membrane preparation and the harmful solvents used. Different strategies have been proposed to produce greener OSN, such as using greener solvents for casting or coating, using low toxicity chemicals, minimizing the number of steps in membrane production to reduce waste, and minimizing energy in preparing casting solutions.

Various polymeric materials such as polyacrylonitrile (PAN), polyimide (PI), polythiosemicarbazide (PTSC), polybenzimidazole (PBI), polyaniline (PANI), polysulfone (PSf)/sulfonated poly (ether-ether ketone) (SPEEK) blends, poly (ether-ether ketone) (PEEK), and copolyazole have been investigated as OSN membranes. Coating and interfacial polymerization of polymers on top of chemically crosslinked supports were also studied as thin film composite membranes. However, there has been very low interest in biopolymers.

### SUMMARY

In general, embodiments of the present disclosure describe alginate membranes for solvent filtration and pervaporation, methods of making alginate membranes, methods of using the membranes for solvent filtration and pervaporation, and the like.

Embodiments of the present disclosure describe thin film composite membranes comprising a crosslinked alginate layer on a surface of a porous woven or non-woven support.

Embodiments of the present disclosure describe a method of making a thin-film composite membrane comprising casting an alginate solution on a porous woven or non-woven support, immersing in an aqueous solution containing a crosslinking agent, and removing solvent by drying at room temperature or immersing in a non-solvent suitable for solvent exchange.

Embodiments of the present disclosure describe a method of making a thin-film composite membrane comprising casting a sodium alginate solution or potassium alginate solution on a porous woven or non-woven support, immersing in an aqueous solution containing a divalent salt, and removing solvent by drying at room temperature or immersing in a non-solvent suitable for solvent exchange.

Embodiments of the present disclosure describe a method of making a freestanding membrane comprising casting an alginate solution on a porous woven or non-woven support, immersing in an aqueous solution containing a crosslinking agent, immersing in a water bath to stop a crosslinking reaction, removing solvent by drying at room temperature or immersing in a non-solvent suitable for solvent exchange, and detaching a crosslinked alginate layer from the porous woven or non-woven support.

Embodiments of the present disclosure describe a method of making an interfacial membrane comprising casting an alginate solution on a first surface of a porous woven or non-woven support, immersing at least a second surface of the porous woven or non-woven support in an aqueous solution containing a crosslinking agent, or soaking the porous woven or non-woven support in the aqueous solution containing a crosslinking agent, wherein the crosslinking reaction occurs at a casted solution-support interface, and immersing in a water bath to stop a crosslinking reaction.

Embodiments of the present disclosure describe a method of manufacturing membranes comprising casting an alginate solution on a non-woven support feed, immersing the solution-casted non-woven support feed in an aqueous solution containing a crosslinking agent, and removing solvent by drying at room temperature or immersing in a non-solvent exchange bath.

Embodiments of the present disclosure describe methods of separating chemical species comprising contacting a first side of a membrane prepared according to the methods of the present disclosure with a feed stream containing one or more solutes dissolved in water and/or an organic solvent and separating one or more chemical species by organic solvent nanofiltration or pervaporation.

Embodiments of the present disclosure describe methods of separating chemical species by organic solvent nanofiltration comprising contacting a first side of a membrane with a feed stream containing one or more solutes dissolved and/or present in water and/or an organic solvent and collecting a permeate from a second side of the membrane.

Embodiments of the present disclosure describe methods of separating chemical species by pervaporation comprising contacting a first side of a membrane with a liquid feed stream containing one or more solutes dissolved in water or an organic solvent and collecting a permeate in a vapor or gas phase from a second side of the membrane.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing a composite membrane, according to one or more embodiments of the present disclosure.

FIG. 2 is a flowchart of a method of making a freestanding membrane, according to one or more embodiments of the present disclosure.

FIG. 3 is a flowchart of a method of making an interfacial membrane, according to one or more embodiments of the present disclosure.

FIG. 4 is a flowchart of a method of manufacturing membranes, according to one or more embodiments of the present disclosure.

FIG. 5 is a flowchart of a method of separating chemical species using membranes formed according to the methods of the present disclosure, according to one or more embodiments of the present disclosure.

FIG. 6 is a flowchart of a method of separating chemical species by organic solvent nanofiltration, according to one or more embodiments of the present disclosure.

FIG. 7 is a flowchart of a method of separating chemical species by pervaporation, according to one or more embodiments of the present disclosure.

FIG. 8 is a schematic diagram of a chemical structure of a sodium alginate polymer with mannuronic (M) and guluronic (G) acid blocks, according to one or more embodiments of the present disclosure.

FIGS. 9A-9B are schematic diagrams of a preparation procedure of thin film composite NaAlg (route A) and CaAlg (route B) membranes, according to one or more embodiments of the present disclosure.

FIG. 10 is a schematic diagram of a chemical crosslinking reaction of NaAlg polymer and CaCl₂ salt solution, according to one or more embodiments of the present disclosure.

FIG. 11 is a schematic diagram of a preparation procedure of freestanding CaAlg membranes, according to one or more embodiments of the present disclosure.

FIGS. 12A-12B are schematic diagrams of a preparation procedure of interfacial alginate membranes, where a) preparation of alginate membranes on the interfacial surface of crosslinker bath and b) casting of alginate on presoaked support with a crosslinker solution, according to one or more embodiments of the present disclosure.

FIG. 13 is an image of a dried thin alginate film after detaching from CaCl₂/water soaked polyester, according to one or more embodiments of the present disclosure.

FIG. 14 is a schematic diagram of non-solvent induced phase separation alginate membrane prepared by casting on polyester then precipitation in acetone, according to one or more embodiments of the present disclosure.

FIG. 15 is an image of alginate freestanding films experiencing folding effect, according to one or more embodiments of the present disclosure.

FIG. 16 is a graphical view of FTIR-analysis of NaAlg and CaAlg alginate membranes, according to one or more embodiments of the present disclosure.

FIGS. 17A-17D are SEM surface images of a) PAN support, b) 1% NaAlg coated PAN precipitated in acetone, c) 1% NaAlg coated PAN dried at room temperature and d) 1% NaAlg precipitated in 5% CaCl₂ for 5 min, according to one or more embodiments of the present disclosure.

FIGS. 18A-18B are AFM height mappings of a) 1% alginate on PAN crosslinked with 5% CaCl₂ for 30 min and b) 3% alginate on polyester crosslinked with 5% CaCl₂ for 5 min, according to one or more embodiments of the present disclosure.

FIGS. 19A-19G relate to 1% NaAlg spin coated alginate membranes on alumina (5% CaCl₂, 5 min), where a) and b) cross-section SEM images, c) photograph of 1% alginate nanofilm crosslinked in 5% CaCl₂ for 5 min fixed on alumina, d) photograph of 1% alginate nanofilm crosslinked in 5% CaCl₂ for 5 min fixed on a metal ring, e) and f) AFM surface topography of alginate layer after being separated from alumina and fixed on silicon wafer and g) the corresponding height profile, according to one or more embodiments of the present disclosure.

FIGS. 20A-20C are AFM Surface images of a) 0.5% alginate on PAN, b) 1% alginate on Alumina and c) 3% alginate on polyester membranes crosslinked 5% CaCl₂ for 5 min, according to one or more embodiments of the present disclosure.

FIGS. 21A-21F are SEM surface images of the CaAlg membranes on polyester support where a) and d) represent surface images of 3% and 1% NaAlg concentration, b) and c) cross-section image of 3% NaAlg membrane, e) represent the cross-section of 1% NaAlg membrane and f) photograph of membranes with 1% and 3% concentration showing detachment of the film, according to one or more embodiments of the present disclosure.

FIGS. 22A-22B are water contact angle measurements of a) PAN support, and b) 1% alginate crosslinked with 5% CaCl₂ for 30 min film on PAN support, according to one or more embodiments of the present disclosure.

FIG. 23 is a graphical view of solvent filtration using the same freestanding alginate membrane with 1% NaAlg and 5% CaCl₂ 5 min crosslinker on alumina support, according to one or more embodiments of the present disclosure.

FIGS. 24A-24C are cross-section SEM images of symmetric alginate membranes for: column (a) 1% NaAlg crosslinked then dried, column (b) 3% NaAlg crosslinked then dried and column (c) 3% NaAlg crosslinked then immersed in acetone for 2 min, according to one or more embodiments of the present disclosure.

FIGS. 25A-25C are FIB cross-section images of 3% alginate symmetric membrane crosslinked then left to dry, according to one or more embodiments of the present disclosure.

FIGS. 26A-26D are graphical views of UV-Vis analysis of feed, permeate and retentate samples of VB12 in methanol and DMF solvents for alginate thin film composite membranes on PAN and XPAN supports, according to one or more embodiments of the present disclosure.

FIGS. 27A-27D are graphical views of UV analysis of feed, permeate and retentate of Vitamin B12 in methanol, DMF, DMSO and NMP filtered through alginate freestanding membrane on alumina, according to one or more embodiments of the present disclosure.

FIGS. 28A-28D are graphical views of UV analysis of feed, permeate and retentate of different dyes (MO=methyl orange, Bb=Brilliant blue, VB12=Vitamin B 12) in methanol and DMSO filtered through 3% free-standing alginate membrane on polyester, according to one or more embodiments of the present disclosure.

FIG. 29 is a schematic diagram of an example of a membrane comprising a crosslinked alginate layer on a surface of a woven or non-woven porous support, according to one or more embodiments of the present disclosure.

FIGS. 30A-30B are a schematic diagram of the chemical structure of (a) an alginate polymer and (b) a crosslinked alginate, according to one or more embodiments of the present disclosure.

FIG. 31 is a schematic diagram of a method of preparing thin film composite membranes, according to one or more embodiments of the present disclosure.

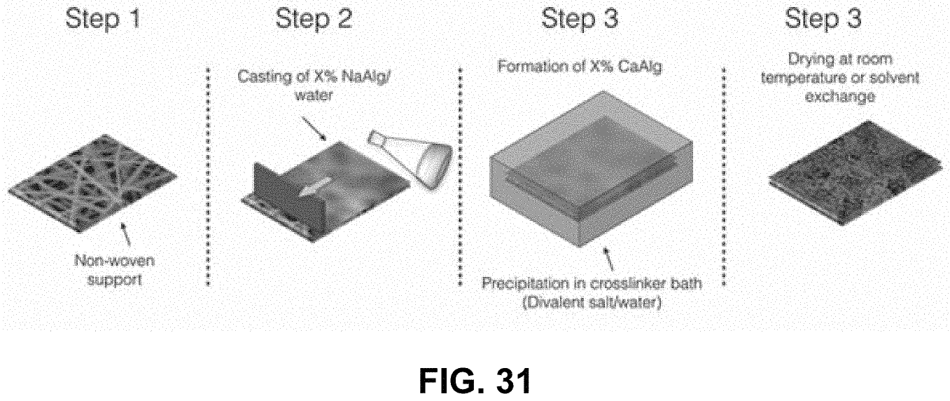

FIG. 32 is a schematic diagram of an example of a process for manufacturing alginate thin film composite membranes using a casting machine, according to one or more embodiments of the present disclosure.

FIG. 33 is a cross-section SEM image of 1% alginate membrane on non-woven support and crosslinked in 5% CaCl2 for about 5 min, according to one or more embodiments of the present disclosure.

FIG. 34 shows cross-section SEM images of 3% alginate membrane on non-woven support and crosslinked in about 5% CaCl2 for about 5 min, according to one or more embodiments of the present disclosure.

FIG. 35 is a graphical view illustrating MWCO in water of 3% alginate thin film composite membranes on non-woven polyester crosslinked with 5% CaCl₂ for about 5 min then dried at about room temperature, according to one or more embodiments of the present disclosure.

FIG. 36 is a graphical view illustrating MWCO in methanol of 3% alginate thin film composite membranes on non-woven polyester crosslinked with about 5% CaCl₂ for about 5 min then dried at about room temperature, according to one or more embodiments of the present disclosure.

### DETAILED DESCRIPTION

The invention of the present disclosure relates to biopolymer-based membranes. In particular, the invention of the present disclosure relates to alginate-based membranes, methods of making the alginate-based membranes, methods of manufacturing the alginate-based membranes, methods of separating chemical species by pervaporation and organic solvent nanofiltration, among others, and the like. The membranes described herein may be prepared as composite membranes or thin-film composite membranes comprising an alginate crosslinked layer on a surface of a porous woven or non-woven support. The membranes exhibit unprecedented stability in water and/or organic solvents such that the membranes may be used in the separation of any chemical species in any solvents.

The alginate-based membranes may be readily and easily prepared by, for example, reaction induced phase inversion, among other mechanisms, to produce defect-free alginate-based membranes. For example, the membranes may be prepared by casting an alginate solution, such as a sodium alginate solution or potassium alginate solution, on a porous woven or non-woven support, immersing in an aqueous solution containing a divalent salt, such as calcium chloride or magnesium chloride, and removing solvent by drying at about room temperature or immersing in a non-solvent suitable for solvent exchange, among other techniques. The immersing may induce a crosslinking reaction that transforms the viscous alginate solution into an insoluble gel of crosslinked alginate, inducing phase separation. The methods may be easily scaled for the manufacture and/or large-scale production of such membranes.

The membranes excellent stability in water and any organic solvent make it particularly useful in separations involving harsh solvents, among other types of separations. For example, the membranes of the present disclosure may be used in separations processes such as organic solvent nanofiltration and pervaporation, among others. In applying the membranes of the present disclosure in such processes, the membranes exhibit excellent performance at least with respect to one or more of permeance, rejection, and molecular weight cutoff, among other performance features and characteristics.

### Definitions

The terms recited below have been defined as described below. All other terms and phrases in this disclosure shall be construed according to their ordinary meaning as understood by one of skill in the art.

As used herein, “casting” refers to disposing a material on a substrate. For example, casting may include disposing an alginate-containing solution on a support. Pouring, spreading, and spin-coating are non-limiting examples of casting. Casting may be achieved using a continuous casting machine and/or a casting knife, among other devices. Other techniques known in the art may be used herein.

As used herein, “contacting” refers to the act of touching, making contact, or of bringing to close or immediate proximity, including at the cellular or molecular level, for example, to bring about a physiological reaction, a chemical reaction, or a physical change (e.g., in solution, in a reaction mixture, in vitro, or in vivo). Contacting may refer to bringing two or more components in proximity, such as physically, chemically, electrically, or some combination thereof. Mixing is an example of contacting.

As used herein, “detaching” refers to separating a material from a substrate. Detaching may include separating a film or membrane from a support. Detaching may optionally proceed without degrading or damaging the film or membrane such that it may be transferred to a second support for use in filtration or pervaporation processes.

As used herein, “immersing” refers to positioning an object in a solution sufficient for the solution to make contact with the object or a part thereof. The object may be partially immersed or completely immersed (e.g., submerged). An example of immersing includes soaking.

As used herein, “collecting” refers to recovering a component, such as a permeate or retentate. The component may include or be a product and one or more other chemical species. The product may also be an isolated product without any impurities, with a low concentration of impurities, or with a negligible concentration of impurities.

As used herein, “removing” refers to reducing a presence of a solvent. The removing may be achieved by drying at about room temperature, immersing in a non-solvent for solvent-exchange, or any other technique known in the art.

As used herein, “separating” refers to the process of removing a substance from another.

As used herein, “molecular weight cutoff” or “MWCO” refers to the molecular weight of a molecule that is 90% retained by the membrane.

Embodiments of the present disclosure describe biopolymer-based membranes in a variety of forms, such as composite membranes or thin film composite membranes, freestanding membranes, and the like. The membranes described herein may exhibit an unprecedented stability across a wide array of solvents, including water and/or organic solvents, making them particularly useful in applications, such as organic solvent nanofiltration (OSN), pervaporation, membrane contactors, and the like. For example, the membranes described herein may be used for any separations in any solvents, including, but not limited to, one or more of water, dimethyl sulfoxide (DMSO), dimethylformamide (DMF), tetrahydrofuran (THF), methanol, ethanol, toluene, n-methyl 2-pyrrolidone (NMP), and acetone, among others.

The biopolymer-based membranes may be formed by reaction induced phase inversion, non-solvent induced phase inversion, and/or interfacial crosslinking based on diffusion, among other techniques. In many embodiments, the biopolymer-based membranes are formed by reaction induced phase inversion. In other embodiments, other techniques such as non-solvent induced phase inversion and interfacial crosslinking may be used.

The biopolymer-based membranes may comprise a crosslinked biopolymer layer on a porous support, such as on a surface or top of the porous support. For example, in some embodiments, the biopolymer-based membranes may include a crosslinked biopolymer layer that covers or substantially covers the pores of the porous support. The crosslinked layer may include a dense thin layer, such as a thin film, with a highly flat surface and/or with varying degrees of penetration into the pores of the porous support. For example, in some embodiments, the biopolymer-based membranes may have minimal pore intrusion such that the membranes do not suffer from severe pore penetration. In other embodiments, the crosslinked biopolymer layer may be prepared independently from the porous support. In these embodiments, the crosslinked biopolymer layer exhibits substantially no pore intrusion.

The crosslinked biopolymer layer may include any biopolymer capable of being crosslinked. The biopolymer may include or be based on one or more of alginate, cellulose, and chitosan. In many embodiments, the crosslinked biopolymer layer includes or is based on alginate. The alginate may, for example, be an unbranched binary copolymer of 1-4 linked β-D-mannuronic acid (M) and α-L guluronic acid (G). The alginate may be built of G-G blocks, G-M blocks, and M-M blocks. These blocks may be present in varying ratios and molecular weights to control the physical and chemical characteristics of the final polymer. The crosslinked biopolymer layer may include a crosslinked alginate layer including an ion of the crosslinker (e.g., a cation of the divalent salt). For example, in an embodiment, the crosslinked biopolymer layer includes a crosslinked calcium alginate layer. In an embodiment, the crosslinked biopolymer layer includes a crosslinked magnesium alginate layer.

The crosslinked biopolymer layer may have a thickness ranging from about 0.1 μm to about 5 μm. In many embodiments, a thickness of the crosslinked biopolymer layer may range from about 0.3 μm to about 1.5 μm. In a preferred embodiment, a thickness of the crosslinked biopolymer layer may range from about 0.7 μm to about 2 μm. In an embodiment, a thickness of the crosslinked biopolymer layer may be about 370 nm, about 700 nm, about 1.3 μm, or about 1.7 μm. In other embodiments, a thickness of the crosslinked biopolymer layer may be less than about 0.1 μm and/or greater than about 5 μm.

The porous support may include any suitable porous support, such as a polymeric porous support or an inorganic porous support. For example, the porous support may include one or more of polyacrylonitrile (PAN), crosslinked polyacrylonitrile (XPAN), non-woven polyester, cellulose, alumina (e.g., alumina disc), and silicon (e.g., silicon wafer). In other embodiments, the supports may include one or more of glasses, ceramics, glass ceramics, carbon, metals, and clays. Suitable first supports may include one or more of metal oxide, alumina (e.g., alpha-aluminas, delta-aluminas, gamma-aluminas, or combinations thereof), cordierite, mullite, aluminum titanate, titania, zeolite, metal (e.g., stainless steel), ceria, magnesia, talc, zirconia, zircon, zirconates, zirconia-spinel, spinel, silicates, borides, alumino-silicates, porcelain, lithium alumino-silicates, feldspar, magnesium alumino-silicates, fused silica, carbides, nitrides, silicon carbides, silicon nitrides, and the like.

The porous support may be woven or non-woven and/or hydrophobic or hydrophilic. In many embodiments, the porous support includes a non-woven or hydrophobic porous support. In preferred embodiments, the porous support includes a hydrophobic non-woven porous support. The porous support may be characterized by a low porosity or a high porosity. In many embodiments, high porosity may enhance membrane performance by reducing the support's resistance to solvent and/or solute transport.

The porous support may be one or more of a microporous material, mesoporous material, and macroporous material. An average pore size (e.g., average pore diameter) of a microporous material may be less than about 2 nm. An average pore size of a mesoporous material may range from about 2 nm to about 50 nm. An average pore size of a macroporous material may be greater than about 50 nm. In many embodiments, the porous support is one or more of a mesoporous material and a macroporous material. For example, in an embodiment, an average pore size of the porous support may range from about 50 nm to about 200 nm. In a preferred embodiment, an average pore size of the porous support is about 200 nm or greater. In other embodiments, an average pore size of the porous support may be less than about 50 nm and/or greater than about 200 nm.

The biopolymer-based membranes may have a molecular weight cutoff ranging from about 200 g/mol to about 1,500 g/mol. In many embodiments, the molecular weight cutoff ranges from about 200 g/mol to about 1,000 g/mol.

Embodiments of the present disclosure describe methods of preparing a composite membrane, such as thin-film composite membranes. The methods described herein may be applied to prepare the biopolymer-based composite membranes by reaction-induced phase inversion, non-solvent induced phase inversion, or a combination thereof. Although embodiments include alginate as a biopolymer, such embodiments shall not be limiting. Any of the biopolymers and porous supports of the present disclosure may be used in the methods described herein.

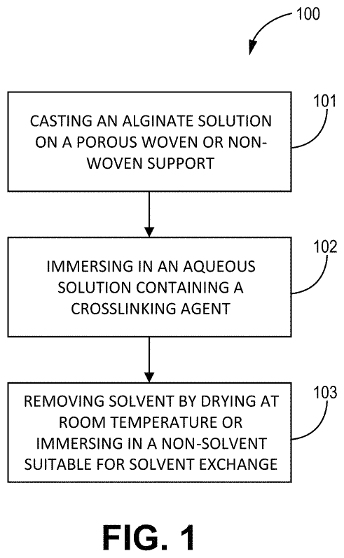

FIG. 1 is a flowchart of a method of preparing a composite membrane, according to one or more embodiments of the present disclosure. As shown in FIG. 1, the method 100 may comprise casting 101 an alginate solution on a porous woven or non-woven support, immersing 102 in an aqueous solution containing a crosslinking agent, and removing 103 solvent by drying at room temperature or immersing in a non-solvent suitable for solvent exchange.

The step 101 includes casting an alginate solution on a porous woven or non-woven support. In this step, an alginate solution is prepared and casted on the porous support. The alginate solution may include or be prepared from an alginate compound, such as a water-soluble salt of alginic acid with monovalent cations. For example, in many embodiments, the alginate compound may include one or more of sodium alginate and potassium alginate. An alginate solution may be formed by dissolving the alginate compound in water, optionally under stirring. A concentration of alginate may be adjusted to control a thickness of the membrane. For example, the concentration of the alginate compound in the solution may range from greater than about 0% to about 5%, or more preferably from about 0.5% to about 5%. Once provided or prepared, the alginate solution may be cast on a porous woven or non-woven support. In many embodiments, the porous support includes one or more of polyacrylonitrile (PAN), crosslinked polyacrylonitrile (XPAN), non-woven polyester, cellulose, alumina, silicon, and glass.

The step 102 includes immersing in an aqueous solution containing a crosslinking agent. In many embodiments, the immersing step is performed immediately or shortly after casting. For example, the solution-casted support does not require any drying or solidifying of the membrane prior to the immersing. In this step, the alginate compound of the alginate film cast on the support and crosslinking agent are immersed (e.g., contacted) in a solvent in which the alginate compound and crosslinking agent are both soluble and/or dissolve so that the crosslinking reaction promotes and/or induces phase separation. The duration of the immersing can range from about 30 seconds to about 30 minutes. Upon the immersing, a crosslinking reaction between the alginate film cast on the support and the crosslinking agent (e.g., divalent salt water solution) may proceed. In many embodiments, the alginate compound of the alginate film or alginate solution cast on the support includes functional groups that undergo rapid crosslinking (e.g., within seconds), leading to precipitation of the polymer. For example, the immersing may transform the viscous alginate film cast on the support into a gel film and/or hydrogel network formed at a surface of the support. This transformation may form a solvent-resistant dense layer that no longer dissolves or is soluble in the solvent, resulting in phase separation. In some embodiments, this mechanism of one or more of crosslinking reaction, precipitation, and phase separation may be referred to as reaction induced phase inversion.

The crosslinking agent contained in the aqueous solution may include any suitable divalent salt. For example, in many embodiments, the crosslinking agent includes one or more of calcium chloride and magnesium chloride. In other embodiments, other crosslinking agents and solvents may be used herein provided that the polymer and crosslinking agent both are soluble and/or dissolve in the solvent. A concentration of the crosslinking agent in the solution may range from about greater than 0% to about 10% by weight, such as about 0.5% to about 10% by weight.

The choice of crosslinking agent, concentration of the crosslinking agent, and immersion time may affect the overall performance of the final membrane in various applications, such as organic solvent nanofiltration and pervaporation, among others. For example, a divalent salt selected as the crosslinking agent may control a rate of the crosslinking reaction, where a higher reactivity generally results in denser membranes with higher thicknesses. The concentration of the divalent salt may control membrane selectivity, where higher concentrations result in denser membranes. The immersion time may be highly affected by the duration of the immersion or crosslinking reaction. In preferred embodiments, the duration of the immersing is about 5 min. In other embodiments, the duration of the immersing may be greater than about 5 min. or less than about 5 min.

The step 103 includes removing solvent by drying at room temperature or solvent exchange. In this step, solvent is removed to dry and convert the gel film into a solid, forming the thin film composite membrane. In many embodiments, the thin film composite membrane includes a crosslinked alginate layer on a porous woven or non-woven support. Removing solvent may proceed by drying at about room temperature or solvent exchange by immersion in a non-solvent. The non-solvent may include a highly volatile non-solvent. An example of a suitable non-solvent may include acetone, among others.

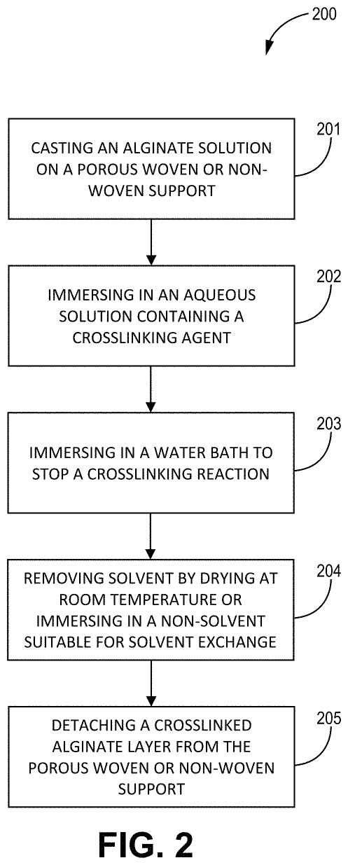

FIG. 2 is a flowchart of a method of making a freestanding membrane, according to one or more embodiments of the present disclosure. As shown in FIG. 2, the method 200 may comprise casting 201 an alginate solution on a porous woven or non-woven support, immersing 202 in an aqueous solution containing a crosslinking agent, immersing 203 in a water bath to stop a crosslinking reaction, removing 204 solvent by drying at room temperature or immersing in a non-solvent suitable for solvent exchange, and detaching 205 a crosslinked alginate layer from the porous woven or non-woven support. The detached alginate layer may be used as a freestanding membrane or may optionally be transferred to a second support (not shown). As many of the steps of the method 100 are similar to or the same as the steps of the method 200 (e.g., steps 201, 202, and 204), the discussion of the method 100 is hereby incorporated by reference in its entirety.

To form the freestanding membrane, polymer intrusion into the pores of the first support may be minimal such that the crosslinked/precipitated alginate layer may be detached, delaminated, or separated from the support and used as a freestanding membrane or optionally transferred to a second support. To minimize polymer intrusion or otherwise form a film capable of being detached, the method 200 may comprise, among other things, immersing 203 in a water bath to stop a crosslinking reaction and, for example, control the extent of polymer intrusion. In addition or in the alternative, various parameters, such as the concentration of alginate in the alginate solution, choice of the support, choice of crosslinking agent, concentration of crosslinking agent, and immersion time, among other parameters, may be selected to control the extent of polymer intrusion into the pores of the support. For example, in an embodiment, the support may include a first support selected to minimize polymer intrusion (e.g., intrusion of crosslinked and/or precipitated alginate) into pores of the first support.

The step 205 includes detaching the crosslinked alginate layer from the support. In this step, the crosslinked alginate layer may be detached, separated, delaminated, and/or the like from the support. In many embodiments, the crosslinked alginate layer may be detached from the support due to minimal polymer intrusion into the pores of the support. The detached crosslinked alginate layer or film may be used as a freestanding membrane or may optionally be transferred to a second support.

In some embodiments, the method 200 may further comprise transferring 206 the detached alginate layer to a second support (not shown). The second support may include any of the supports described herein. In many embodiments, the second support may include one or more of alumina and silicon wafer.

In an embodiment, the casting step 201 may include casting, by spin-coating or other similar techniques, the alginate solution, which may include any of the alginate solutions described herein, onto a first support, such as a glass support. The immersing step 202 may include immersing the solution-casted glass support in an aqueous solution containing a divalent salt as crosslinking agent to precipitate or form an alginate polymer, membrane, or film. The immersing 203 or washing step, such as washing with water, to terminate or quench the crosslinking reaction. The removing step 204 may include drying at about room temperature. The detaching step 205 may include separating the alginate film from the support. An optional step 206 may include transferring the detached alginate film to a second support, such as an alumina support.

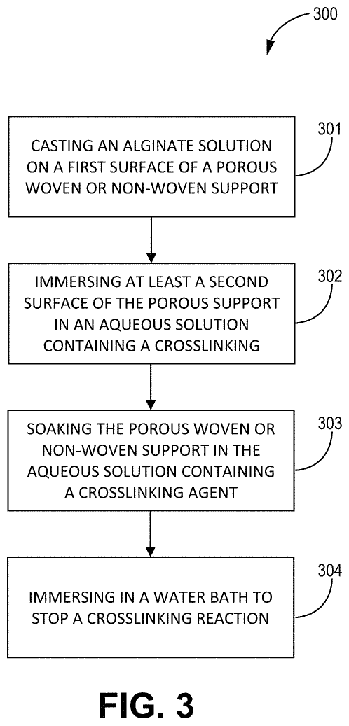

FIG. 3 is a flowchart of a method of making an interfacial membrane, according to one or more embodiments of the present disclosure. As shown in FIG. 3, the method 300 may include casting 301 an alginate solution on a first surface of a porous woven or non-woven support, immersing 302 at least a second surface of the porous woven or non-woven support in an aqueous solution containing a crosslinking agent, or soaking 303 the porous woven or non-woven support in the aqueous solution containing a crosslinking agent, wherein the crosslinking reaction occurs at a casted solution-support interface, and immersing 304 in a water bath to stop a crosslinking reaction. As the steps of the methods 100 and 200 are similar to or the same as one or more steps of the method 300 (e.g. 301 and 304), the discussion of the method 100 and 200 are hereby incorporated by reference in their entirety.

The step 302 includes immersing at least a second surface of the porous support in an aqueous solution containing a crosslinking agent, wherein the crosslinking reaction occurs at a casted solution-support interface. In this step, the crosslinking reaction and/or precipitation of the crosslinked alginate layer may proceed by interfacial crosslinking. The first surface and second surface may be the same or different. In many embodiments, the first surface and the second surface are different. For example, in an embodiment, the first surface may be a top surface of the porous support and the second surface may be a bottom surface of the porous support. In an embodiment, the second surface may include a side surface of the porous support or a surface of the porous support other than the first surface, however defined. The immersing (e.g., contacting) of the second surface proceeds such that the first surface and/or casted alginate solution may not be in direct contact with the aqueous solution containing the crosslinking agent. The crosslinker (e.g., Ca²⁺ ions and/or Mg²⁺ ions of respective divalent salts) may diffuse through the porous support from the second surface to the first surface or the casted solution-support interface (e.g., the interface where the casted alginate solution and porous support or first surface meet), at which point the crosslinking reaction may proceed rapidly.

The step 303 includes soaking the porous woven or non-woven support in the aqueous solution containing a crosslinking agent, wherein the crosslinking reaction occurs at a casted solution-support interface. In this step, the crosslinking reaction and/or precipitation of the crosslinked alginate layer may proceed by interfacial crosslinking. In many embodiments, the porous woven or non-woven support is soaked in the aqueous solution containing the crosslinking agent prior to casting the alginate solution on the porous woven or non-woven support. The soaking may proceed until the support reaches full or partial wetness, preferably full wetness. In some embodiments, extra water droplets may be removed or gently removed prior to casting the alginate solution.

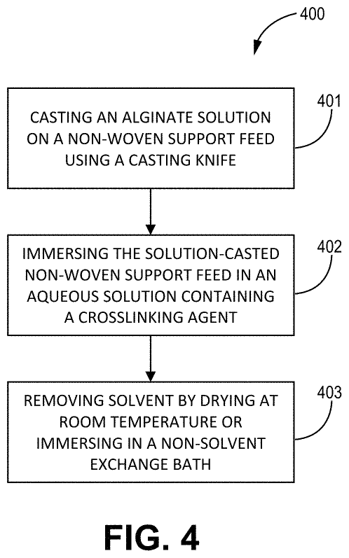

FIG. 4 is a flowchart of a method of manufacturing membranes, according to one or more embodiments of the present disclosure. As shown in FIG. 4, the method 400 may comprise casting 401 an alginate solution on a non-woven support feed. The casting may include continuously casting and/or non-continuously casting (e.g., as in a batch process). The casting may include using a casting knife, a continuous casting machine including a casting knife, and any other machine or apparatus known in the art for casting. In some embodiments, a casting knife is used, which may be adjustable by height to vary a thickness of the alginate solution. The non-woven support feed may be continuously or non-continuously fed to a reservoir including or holding the alginate solution and then cast with the alginate solution. The method 100 may further comprise immersing 402 the solution-casted non-woven support feed in an aqueous solution containing a crosslinking agent, such as a divalent salt. The duration of the immersing may be controlled by the casting speed of the non-woven support. After immersing, the method 100 may further comprise removing 403 solvent by drying at room temperature or immersing in a non-solvent exchange bath.

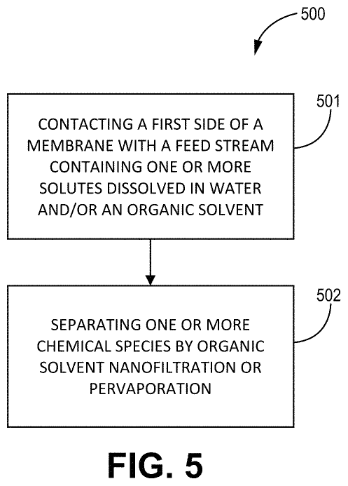

FIG. 5 is a flowchart of a method of separating chemical species using membranes formed according to the methods of the present disclosure, according to one or more embodiments of the present disclosure. As shown in FIG. 5, the method may comprise contacting 501 a first side of a membrane prepared according to the methods of the present disclosure with a feed stream containing one or more solutes dissolved in water and/or an organic solvent and separating 502 one or more chemical species by organic solvent nanofiltration or pervaporation.

The step 501 includes contacting a first side of a membrane prepared according to the methods of the present disclosure with a feed stream containing one or more solutes dissolved in water and/or an organic solvent. Any of the membranes of the present disclosure may be used herein. The organic solvents may include any organic solvent, including, but not limited to, one or more of dimethyl sulfoxide (DMSO), dimethylformamide (DMF), tetrahydrofuran (THF), methanol, ethanol, toluene, n-methyl 2-pyrrolidone (NMP), and acetone.

The step 502 includes separating one or more chemical species by organic solvent nanofiltration or pervaporation. The membranes of the present disclosure may be used for the separation of any chemical species present in and/or using any solvent. In some embodiments, the separating may be based on organic solvent nanofiltration, wherein the separating includes collecting a permeate from a second side of the membrane. In some embodiments, the separation may be based on pervaporation, wherein the separating includes collecting a permeate in a vapor or gas phase from a second side of the membrane.

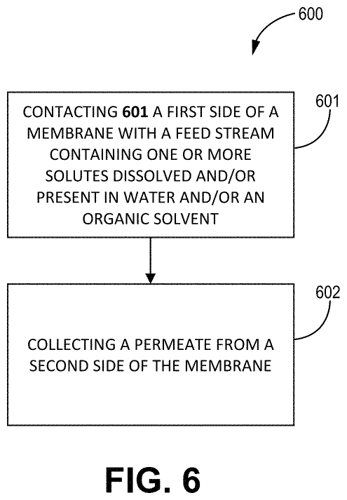

FIG. 6 is a flowchart of a method of separating chemical species by organic solvent nanofiltration, according to one or more embodiments of the present disclosure. As shown in FIG. 6, the method 600 may comprise contacting 601 a first side of a membrane with a feed stream containing one or more solutes dissolved and/or present in water and/or an organic solvent and collecting 602 a permeate from a second side of the membrane. Any of the membranes of the present disclosure may be used herein.

The step 601 includes contacting a first side of a membrane with a feed stream containing one or more solutes dissolved in water or organic solvent. In this step, the feed stream is contacted, usually under pressure, with the first side of the membrane to produce a permeate and a retentate. In many embodiments, the first side of the membrane includes the crosslinked biopolymer layer, such as the crosslinked alginate layer. The permeate may include the solvent (e.g., water or organic solvent) and solute molecules (e.g., small solute molecules) that pass through or permeate the membrane. The retentate may include the solvent and the other solute molecules (e.g., large solute molecules) that are retained or rejected by the membrane (e.g., do not permeate the membrane). A molecular weight cut off may range from about 500 g/mol to about 1,500 g/mol. In an embodiment, the molecular weight cutoff is about 750 g/mol or about 1,200 g/mol.

The feed stream may include one or more solutes dissolved and/or present in a solvent. The solvent may include one or more of water and any organic solvent. For example, the organic solvent may include one or more of dimethyl sulfoxide (DMSO), dimethylformamide (DMF), tetrahydrofuran (THF), methanol, ethanol, toluene, n-methyl 2-pyrrolidone (NMP), acetone, 1-propanol, 2-propanol, 1-butanol, 1-hexanol, 1-octanol, trifluoroethanol, propylene glycol, PEG 400, 1,3-propanediol, diethyl ether, diglyme, decalin, isooctane, mineral oil, benzene, chlorobenzene, pyridine, ethyl acetate, methyl acetate, dichloroethane, ethylene diamine, acetonitrile, and trimethyl phosphate.

The step 602 includes collecting a permeate from a second side of the membrane. In this step, the solvent and solute molecules that passed through or permeated the membrane are collected as the permeate. In some embodiments, the retentate may further be collected and recycled in the process. For example, in an embodiment, the retentate may be collected and re-contacted with the membrane one or more times.

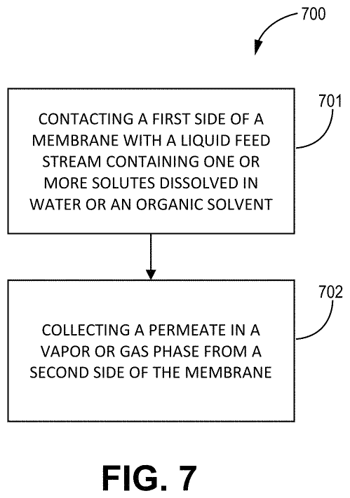

FIG. 7 is a flowchart of a method of separating chemical species by pervaporation, according to one or more embodiments of the present disclosure. As shown in FIG. 7, the method may comprise contacting 701 a first side of a membrane with a liquid feed stream containing one or more solutes dissolved in water or an organic solvent and collecting 702 a permeate in a vapor or gas phase from a second side of the membrane. Any of the membranes of the present disclosure may be used herein.

The step 701 include contacting a first side of a membrane with a liquid feed stream containing one or more solutes dissolved in water and/or any organic solvent. In this step, the liquid feed stream is contacted with the first side of the membrane to produce a vaporous permeate and a retentate. The permeate may permeate through the membrane and evaporated to produce the vaporous permeate. Transport through the membrane may be driven by a difference in partial pressure between the liquid feed stream and the permeate. In many embodiments, a vacuum is applied to provide the partial pressure difference driving force. In other embodiments, an inert gas may be applied to provide the partial pressure difference driving force.

The feed stream may include one or more solutes dissolved and/or present in a solvent. The solvent may include one or more of water and any organic solvent. For example, the organic solvent may include one or more of dimethyl sulfoxide (DMSO), dimethylformamide (DMF), tetrahydrofuran (THF), methanol, ethanol, toluene, n-methyl 2-pyrrolidone (NMP), acetone, 1-propanol, 2-propanol, 1-butanol, 1-hexanol, 1-octanol, trifluoroethanol, propylene glycol, PEG 400, 1,3-propanediol, diethyl ether, diglyme, decalin, isooctane, mineral oil, benzene, chlorobenzene, pyridine, ethyl acetate, methyl acetate, dichloroethane, ethylene diamine, acetonitrile, and trimethyl phosphate.

The step 702 includes collecting a permeate in a vapor or gas phase from a second side of the membrane. In this step, the components of the feed that passed through or permeated the membrane evaporate to form a permeate in a vapor or gas phase, such as a vaporous permeate. In some embodiments, the retentate may further be collected and recycled in the process. For example, in an embodiment, the retentate may be collected and re-contacted with the membrane one or more times.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE 1

Cellulose, the most abundant organic biopolymer, does not melt or dissolve in ordinary solvents due to the presence of strong hydrogen bonds between its chains. Cellulose was considered a strong candidate for organic solvent separation applications. Despite its chemical stability, cellulose is not used as a separation layer for nanofiltration due to its characteristic porous structure. Chitosan as well exhibits excellent resistance to most organic solvents and it is used in pervaporation and OSN.

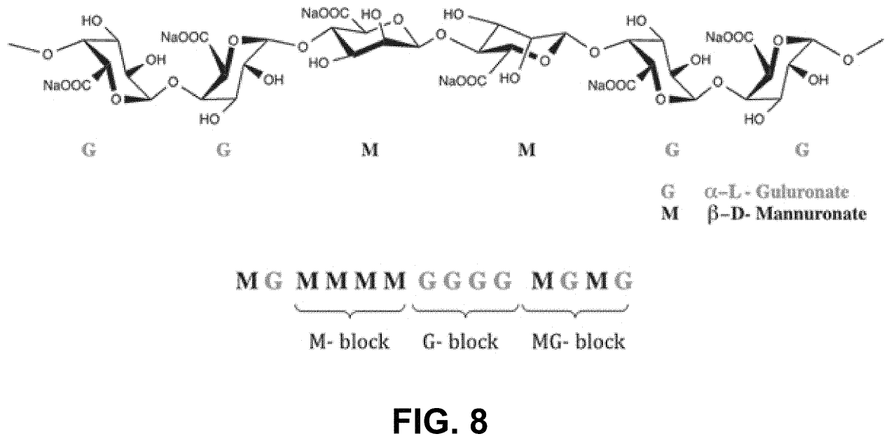

Sodium alginate (NaAlg) is a natural polysaccharide extracted from the cell wall of brown seaweed and it is the water-soluble salt of alginic acid. Alginate is an unbranched binary copolymer of 1-4 linked β-D-mannuronic acid (M) and α-L guluronic acid (G). In principle, alginate is built of G-G blocks, G-M blocks, and M-M blocks (FIG. 8). These blocks can be found in different ratios and molecular weights, dictating the physical and chemical characteristics of the final polymers. Crosslinked NaAlg was a potential candidate for pervaporation applications since crosslinking is essential to increase the membrane stability toward water as well as to enhance the mechanical strength. A number of crosslinking agents have been reported including glutaraldehyde, toluene diisocyanate (TDI), hexanediamine, or jeffamine, and divalent cations such as calcium salts through ionic crosslinking.

In this Example, sodium alginate composite membranes were prepared from NaAlg through the reaction induced phase inversion technique. Water was used a solvent and an aqueous solution of calcium chloride was chosen as the crosslinking agent, aiming to improve the green characteristics of the membrane manufacture. Polyacrylonitrile (PAN), cellulose, non-woven polyester and alumina disc served as supports. The membranes were tested in various solvents including dimethyl sulfoxide, dimethylformamide, and tetrahydrofuran.

Accordingly, the following Example relates to alginate membranes that were prepared by crosslinking of sodium alginate in calcium chloride solution. The membranes were prepared on three different supports and each exhibited similar performance. A good membrane stability in various solvents including dimethylformamide and dimethylsulfoxide was obtained. The molecular weight cut off was about 1,200 g/mol when tested using dyes and vitamin B12 in methanol. This Example demonstrates that alginate membranes are a promising candidate for green organic solvent nanofiltration.

### Materials

Sodium alginate (NaAlg) was purchased from MP Biomedicals LLC. Calcium chloride dihydrate (CaCl₂.2H₂O) was purchased form Fisher chemicals. Polyacrylonitrile (PAN) (GMT, Membrantechnik GmbH, Germany), alumina disc (Anodisc 25, 200 nm pore size, Whatman Ltd.), and polyester (Sojitz Europe, Germany) were used as supports. The crosslinked PAN (XPAN) were prepared through crosslinking of the bare PAN support using hydrazine monohydrate (Sigma-Aldrich). Another support from cellulose was prepared by phase inversion. About 12% w/w cellulose (Avicel PH101, Sigma Aldrich) was dissolved in 1-ethyl-3-methylimidazolium acetate (Sigma Aldrich) at about 80° C. The solution was then cast (300 μm clearance) on a non-woven polyester followed by phase inversion in water. Vitamin B12 (B12) (Sigma Aldrich), methyl orange (ACROS organics) and Brilliant Blue R-250 dyes (Fisher BioReagents), polyethylene glycols (Sigma Aldrich) were used as markers during rejection experiments. Solvents such as dimethyl sulfoxide (DMSO), dimethylformamide (DMF), tetrahydrofuran (THF), methanol, ethanol, toluene, NMP and acetone (all from Sigma Aldrich) were used without further purification.

### Membrane Preparation

First, NaAlg solution was prepared by dissolving NaAlg in water for about 3-8 hours at about room temperature depending on the polymer concentration.

### Thin Film Composite Alginate Membranes on Polymeric Support

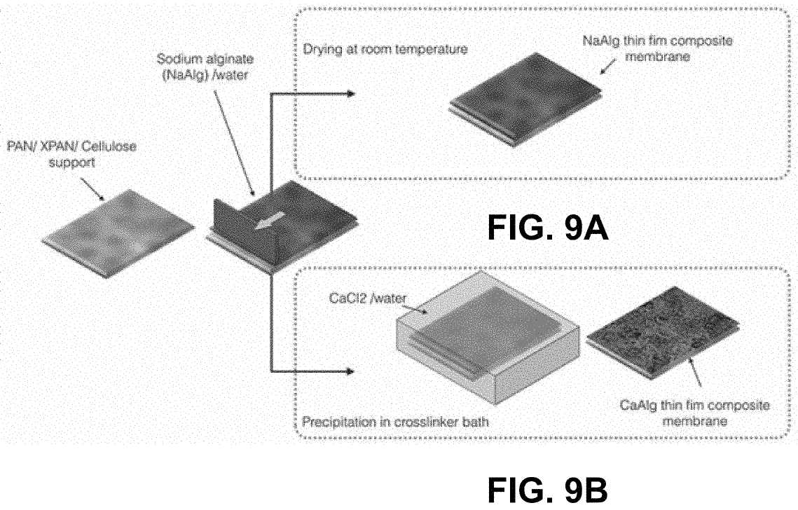

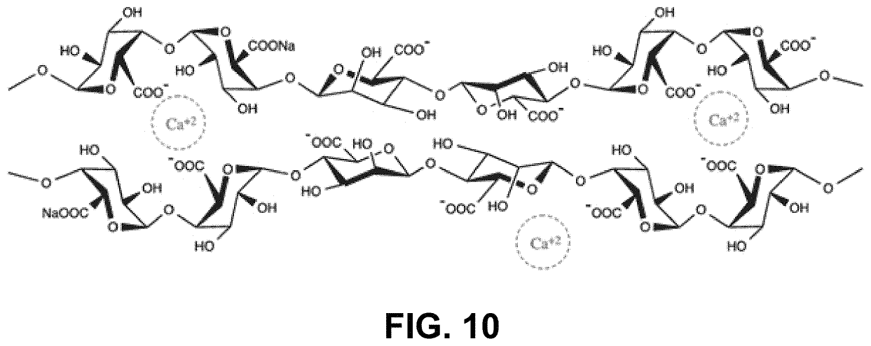

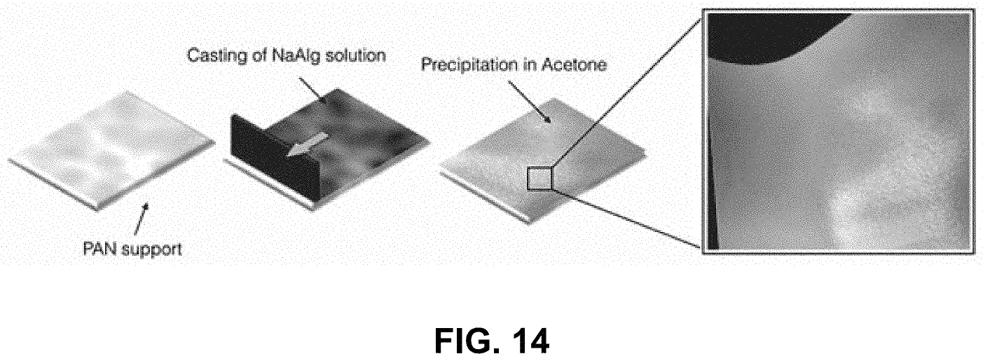

Composite membranes were prepared by casting NaAlg solution (about 150 μm clearance) on top of PAN, crosslinked PAN (XPAN) or cellulose supports as illustrated in FIGS. 9A-9B. Next, the membranes were either left to dry at room temperature or were precipitated in acetone (FIG. 14) or in water bath containing calcium chloride for a certain period of time and then washed with pure water. The calcium ions acted as crosslinking agents (FIG. 10).

### Free-Standing Alginate Membranes on Alumina Support

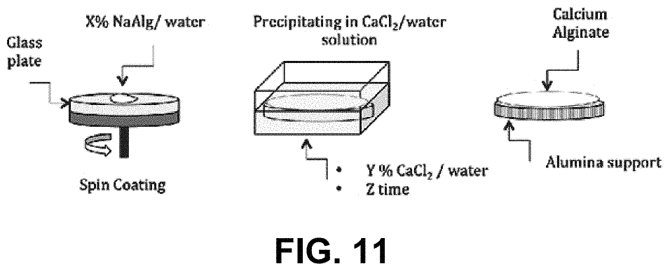

Free-standing NaAlg membranes were prepared by spin coating. A certain percentage of NaAlg solution was spin-coated on a glass slide at about 1000 rpm speed and about 1000 rpms⁻¹ acceleration for about 1 min. After coating the glass plate was immersed in an about 5% CaCl₂/water solution for about 5 min where precipitation of the polymer occurred due to ionic crosslinking, and resulted in the formation of CaAlg membranes. The glass plate was subsequently transferred to a pure water bath to stop the crosslinking reaction. The film was then detached from the glass plate and was transferred to the alumina support. The preparation is outlined in FIG. 11.

### Free-Standing Membranes Prepared on Polyester Support

About 1 or 3% (w/w) NaAlg in water was prepared and casted on a polyester support directly with a thickness of about 150 μm. The cast film was then precipitated in a crosslinker bath containing about 5% CaCl₂ for about 5 min and then transported to a water bath. Finally, the membrane was left to dry at about room temperature.

### Interfacial Alginate Membranes Preparation

Other preparation techniques which depended on an interfacial interaction between the polymer solution and the crosslinker bath were tested such as:

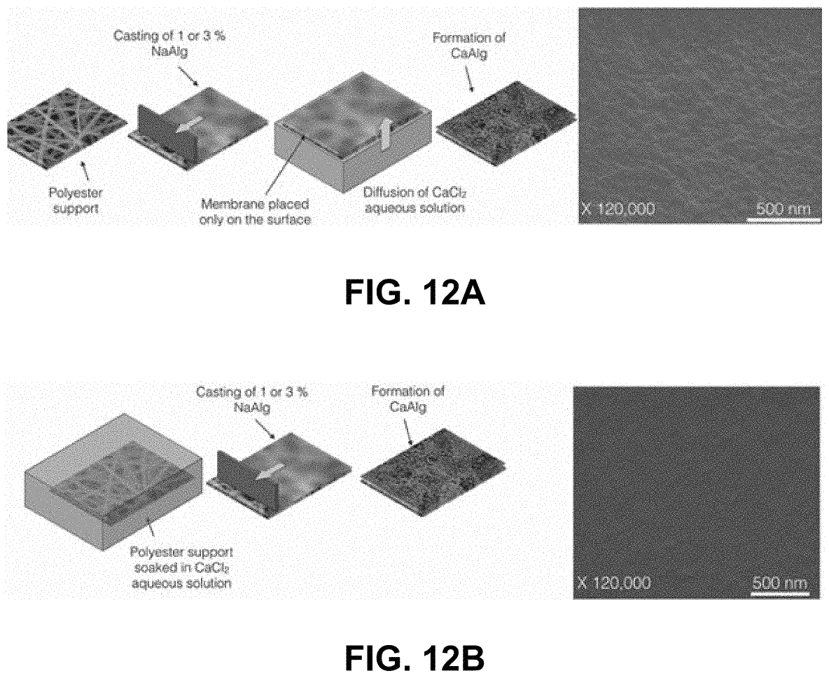

Alginate solution was cast on a polyester support, and then the cast membrane was placed carefully on the surface of an aqueous calcium chloride solution. This approach allowed the diffusion of the calcium ions into the cast alginate film and crosslinked it. After about 5 minutes of reaction the membranes were removed and transported into a water bath to stop the reaction (FIG. 12A).

A polyester support was soaked in aqueous calcium chloride solution until full wetness. Upon soaking, extra water droplets were gently removed and then an alginate solution was cast on top of the wet support. The support was moved into a water bath after allowing a reaction time of about 5 minutes (FIG. 12B).

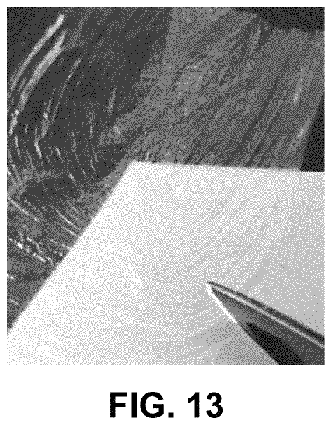

The interfacial alginate membranes prepared following route (a) showed a shinny surface indicating a thin film; however, once tested for VB12/Methanol mixture the flux was very high and no rejection of VB12 was recorded. In the case of route (b) the casting of alginate polymer solution, although possible using casting knife, the film was immediately crosslinked to form a gel that was moving with knife. Eventually the casted film was crosslinked and not connected to the support unlike route (a) where the interface allow slight penetration of alginate into the support where it met the crosslinker form the other side. The thickness of the film was around 9 μm; FIG. 13 shows the detached film. With careful preparation and customization of conditions these two methods may be developed and efficient membranes may be produced.

### Non-Solvent Induced Phase Separation (NIPS) Alginate Membranes

Non-solvent induced phase separation alginate membranes were also possible to prepare by precipitation in acetone upon casting. A densification of the film was noticed upon exposure to acetone and shinny surface was observed after complete dryness (FIG. 14).

### Folding Effect

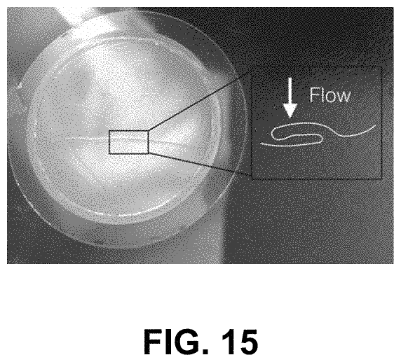

Membrane folding was often experienced when laminating freestanding alginate films on alumina support; this folding created extra resistance to solvent flow and eventually lowered the permeance. FIG. 15.

### Membrane Characterization

The FTIR spectra were recorded on a Nicolet iS10 FTIR spectrometer with a Smart iTR Attenuated Total Reflectance (ATR) sampling accessory in the range of about 500-3500 cm⁻¹ at about room temperature. The samples were fixed between a diamond plate and pressure tower with the separating layer facing the beam. Membranes were dried prior to measurements. Spectra of different membranes were compared.

The surface of the studied membranes was characterized by high-resolution scanning electron microscope (Magellan) or (FEI Nova Nano) at about 2 kV. The samples for cross-section images were obtained by fracturing the membrane in liquid nitrogen. Prior to the SEM imaging the samples were sputtered with about 3 nm thick (Magellan) or about 5 nm (Nova Nano) Iridium coating using Quorum Q150T S sputter coater under an argon atmosphere to achieve the necessary conductivity. Magellan was used to take the cross-section SEM images of the freestanding membranes; the samples were fractured carefully without liquid nitrogen since the support was too brittle to handle.

A Helios Nanolab 400S dual beam SEM equipped with electron beam (field emission source), focused ion beam (FIB) and through-the-lens secondary electron detector (TLD) was used to examine the free-standing membranes cross-section. Membranes were coated with about 7 nm of Pt/Pd inside a K575X sputter coater (Quorum Technologies). Two-steps coating with platinum was used to protect the top surface layer from ion beam-induced damage during subsequent cross-sectioning steps. The membrane surface was first coated with about 200 nm of platinum using e-beam and additional 1200 nm of platinum coating using FIB. The cross-sectioned face of the membranes was imaged using TLD at 5 KV, 52-degree stage tilt angle and 3.9 mm working distance.

The surface topographies were analyzed by AFM on an ICON Veeco microscope operating in the tapping mode using commercial silicon TM AFM tips (MPP 12100). Films were fixed on silicon wafer prior to experiment.

Contact angle measurements were performed with an Easy-Drop Instrument (manufactured by Kruess) at about room temperature using the drop method, in which a drop of water was deposited on the surface of a piece of membrane using a micropipette. The contact angle was measured automatically by a video camera in the instrument using drop shape analysis software. All membranes were dried prior to the measurements. Three measurements were performed on different membrane pieces and the average values were reported.

All nanofiltration experiments were carried out at about 25° C. in a stirred dead-end filtration cell. The effective membrane areas were about 12.6 and 4 cm² for thin film composite and freestanding membranes, respectively. Permeate samples for flux and rejection measurements were collected at steady state. Rejection studies were carried out using a feed solution of about 20-ppm vitamin B12 (MW=1,355 g/mol, size=1.7 nm, charge=neutral) in methanol, DMF, DMSO and NMP. Also, about 5 ppm of both methyl orange (MW=327 g/mol, charge=−1) and Brilliant Blue R-250 (MW=825, charge=−2) dyes were used. 0.2 wt % PEG's (600, 3K, 10K, and 35K g/mol) in water were used to characterize the rejection in water. The rejection of vitamin B12 and other dyes was monitored using a NanoDrop 2000/2000c spectrophotometer (Thermo Fisher Scientific). The rejection of PEG was measured using GPC. Solvent permeance (J) was determined by measuring the permeate volume (V) per unit area (A) per unit time (t) per unit pressure (P) according to equation 1. The rejection (Rᵢ) of dyes was calculated from equation 2, where CPᵢ and CFᵢ corresponded to the permeate and the feed concentrations, respectively. Each filtration experiment reported was at least repeated three times with three membranes.

$$J = \frac{V}{( A * t * P )} \qquad ( 1 )$$

$${R}_{i} = ( 1 - \frac{{CP}_{i}}{{CF}_{i}} ) * 100 \% \qquad ( 2 )$$

### Results and Discussion

### Membrane Structure and Morphologies

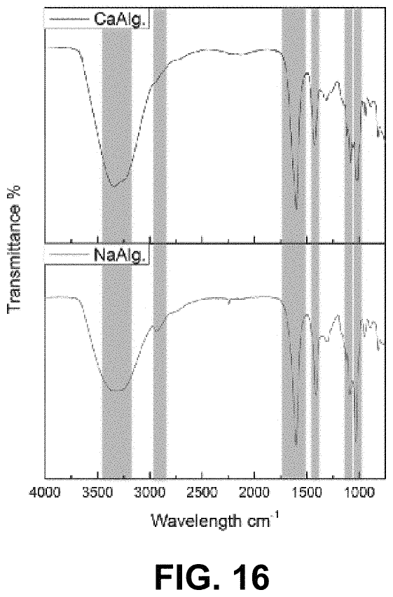

The FTIR spectra of the sodium alginate (NaAlg) and the crosslinked alginate (CaAlg) were recorded and compared in FIG. 16. Spectrum of sodium alginate showed important absorption bands regarding hydroxyl, ether and carboxylic functional groups. Stretching vibrations of O—H bonds of NaAlg appeared in a 3344 cm⁻¹ shift. Stretching vibrations of aliphatic C—H were observed at 2932 cm⁻¹. Observed bands in 1602 and 1413 cm⁻¹ were attributed to asymmetric and symmetric stretching vibrations of carboxylate salt ion, respectively. The bands at 1092 and 1031 cm⁻¹ were attributed to the C—O stretching vibration of pyranose ring and the C—O stretching with contributions from C—C—H and C—O—H deformation. Calcium alginate spectrum showed changes in comparison with IR spectrum of NaAlg. Absorption region of stretching vibrations of O—H bonds in CaAlg appeared narrower than NaAlg. This difference arose from the participation of hydroxyl and carboxylate groups of alginate to the calcium forming a chelate structure and a consequent decrease in hydrogen bonding between hydroxyl groups. Lower shifting for the asymmetric stretching vibration of carboxylate ion (1080 and 1021 cm⁻¹) was noted. This can be explained by the differences in the charge density, molecular weight, and ion radius of the cations once calcium ions replace sodium ions.

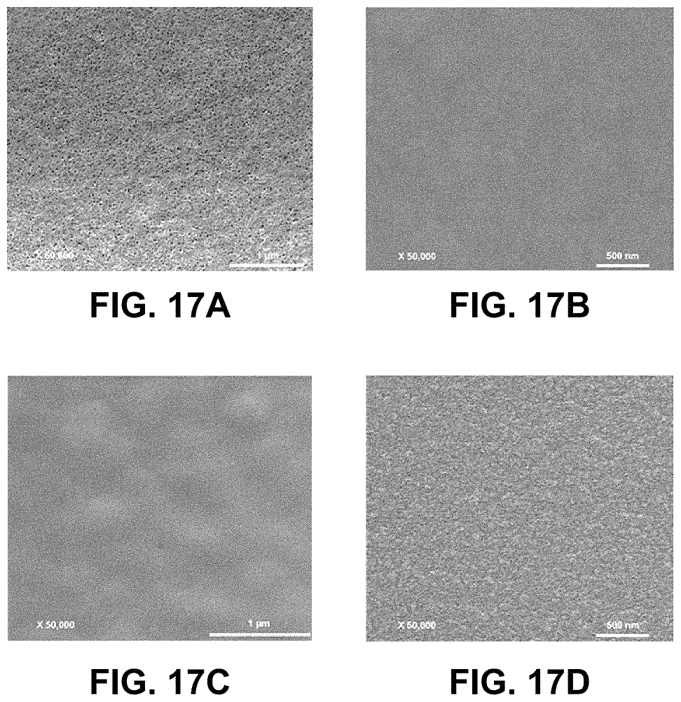

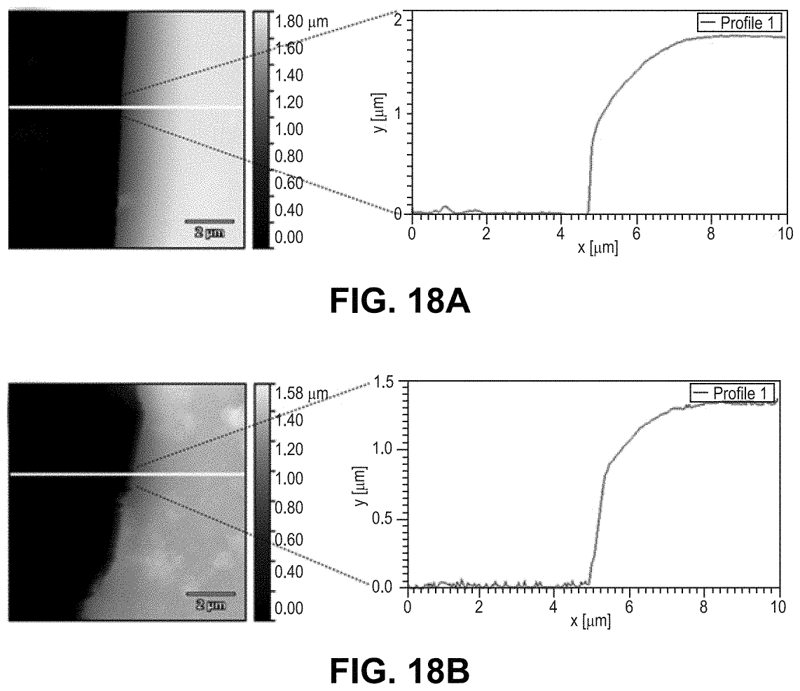

SEM surface images of PAN support, NaAlg coated PAN, and CaAlg crosslinked membranes are presented in FIGS. 17A-17D. PAN porous supports have a pore size of around 50 nm (a). After NaAlg coating, the membranes exhibited a highly flat surface with full coverage of the PAN surface pores. There was no observable difference among all the membrane surfaces regardless of their precipitation method (in acetone (b) or left to dry (c)). Full coverage of PAN support was also obtained for CaAlg membranes (d). The thickness of 1% alginate on PAN estimated using AFM height mapping was about 1.7 μm (FIG. 18A-18B).

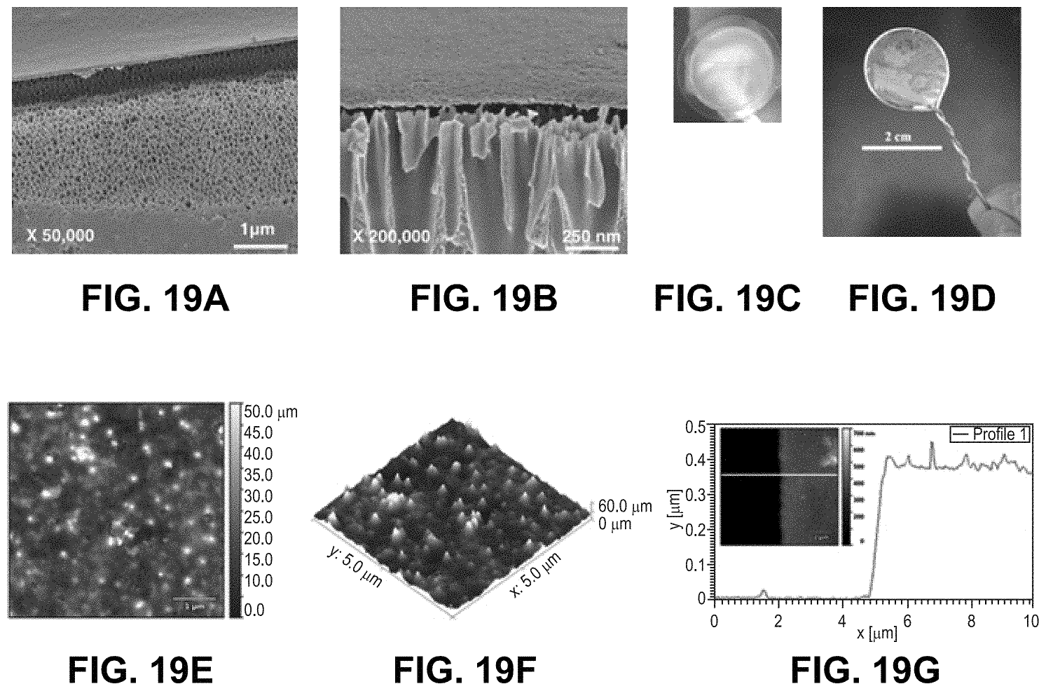

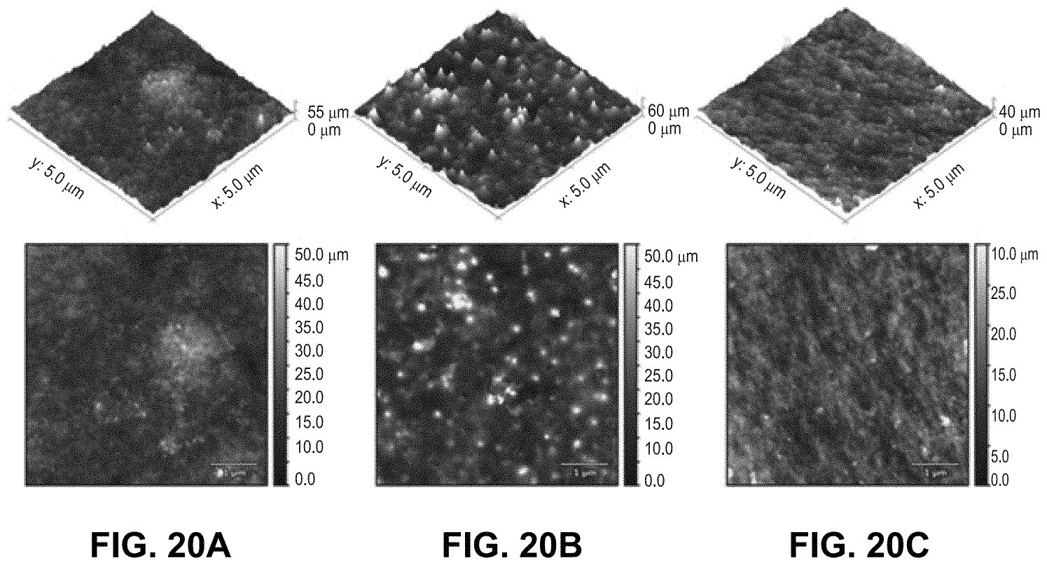

The cross-sectional SEM image in FIG. 19A-19G show, among other things, the 1% CaAlg membranes sitting on top of a highly porous alumina support. From the AFM topography images in FIGS. 19E-19F, it was evident that the roughness of the alumina was imprinted on the surface of alginate even after the delamination of the layer from the alumina and relocation to silicon wafer, the alginate membrane on alumina exhibited a surface with the highest calculated roughness of about 69 nm compared to other supports (FIGS. 20A-20C). Thickness of alginate of about 370 nm was estimated from the AFM height mapping on silicon wafer. FIG. 19C shows the freestanding nanofilm on top of an alumina disc and FIG. 19D illustrates the alginate nanofilm fixed on a 2 cm diameter metal wire ring, demonstrating that the freestanding alginate film had a good integrity although it was only about 370 nm thick.

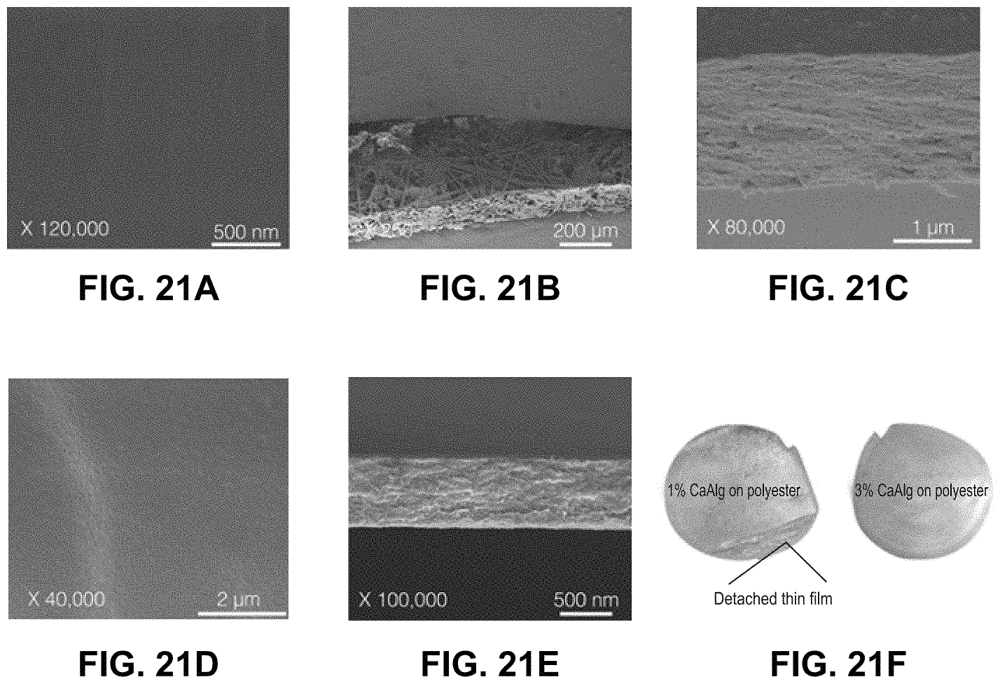

In addition to using the aforementioned supports, crosslinked alginate membranes on top of non-woven polyester were also prepared. SEM surface images of the membranes (FIGS. 21A-21B) demonstrate that the 1 and 3% NaAlg (respectively) casting solution could cover the highly coarse surface of polyester support without any observable voids. FIG. 21B showcases low-resolution cross-section image of 3% alginate on polyester and c) and e) reveal the thickness of the alginate layer of 3% (about 1.3 μm) and 1% (about 700 nm) respectively. Although a full coverage of 1% alginate on polyester can be achieved, the film easily detached from the support as seen on the FIG. 21F, most likely due to the minimum polymer intrusion that occurred in the support pores. The thickness of 3% alginate on polyester was expected to be higher than the thickness of 1% alginate on PAN due to higher concentration, however, (referring to FIG. 18A-18B) the opposite was noted. The only possible explanation was the support used was different. The 1% alginate was cast on the low porosity PAN support with a pore size of 50 nm, while the 3% alginate was cast on the highly open polyester. It was expected that some of the uncrosslinked polymer on the polyester dissolved during the 5-minute crosslinking time, whereas the entire polymer matrix was perfectly crosslinked for about 30 minutes on top of the PAN support.

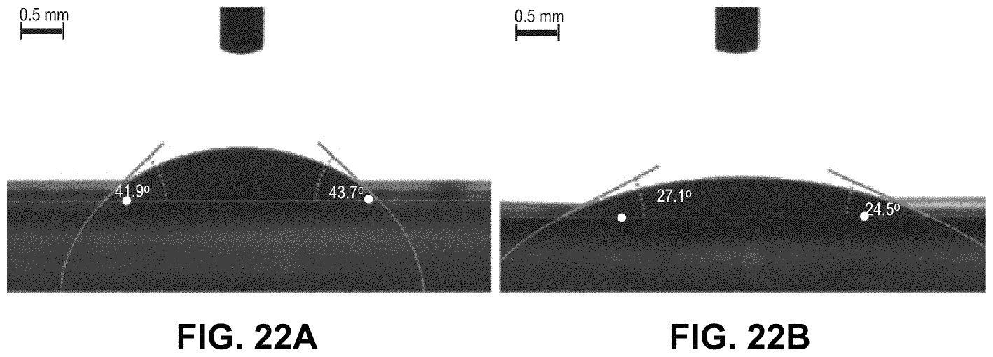

Contact angles were measured on the PAN support and the CaAlg on PAN. FIGS. 22A-22B show a contact angle of around 44° of the PAN support; while the 1% NaAlg coated membrane (crosslinked with about 5% CaCl2 for about 30 min) had a contact angle of about 25°, indicating the presence of the strongly hydrophilic alginate. Contact angle measurement of the uncrosslinked NaAlg membranes was not possible due to its high solubility in water.

### Stability of Free-Standing Alginate Membranes in Solvents

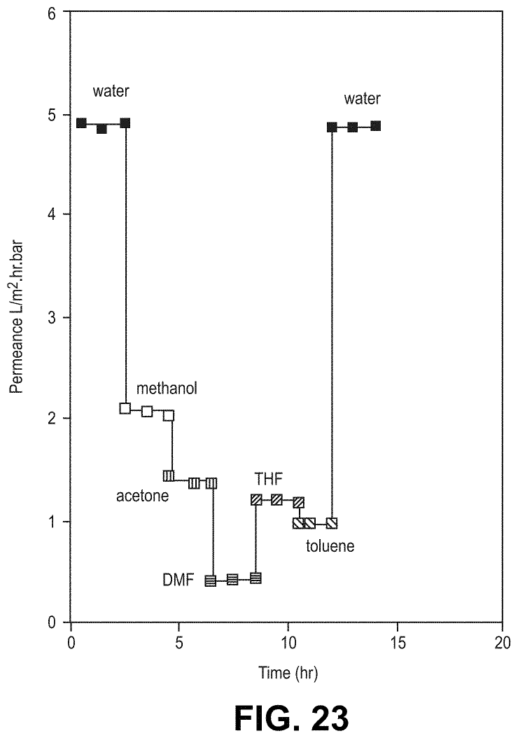

The stability of the alginate/alumina membrane was put to test in more details, 1% NaAlg membrane crosslinked with 5% CaCl₂ for about 5 min was first tested for water filtration, followed by a series of different solvents, and finally for water again. Filtration of different solvents was performed at about 15 bar. The cell was depressurized after the end of each 3 h filtration to change solvent and pressurized again for testing. FIG. 23 shows the filtration of different solvents using the same membranes. The stable performance for each solvent indicated that a steady state was reached and no compaction was encountered. Water filtration was performed at the beginning and the end of the study giving the same performance, which confirmed the high chemical stability of alginate membranes toward harsh solvents.

### Cross-Section Images of Alginate Symmetric Membranes on Polyester Support

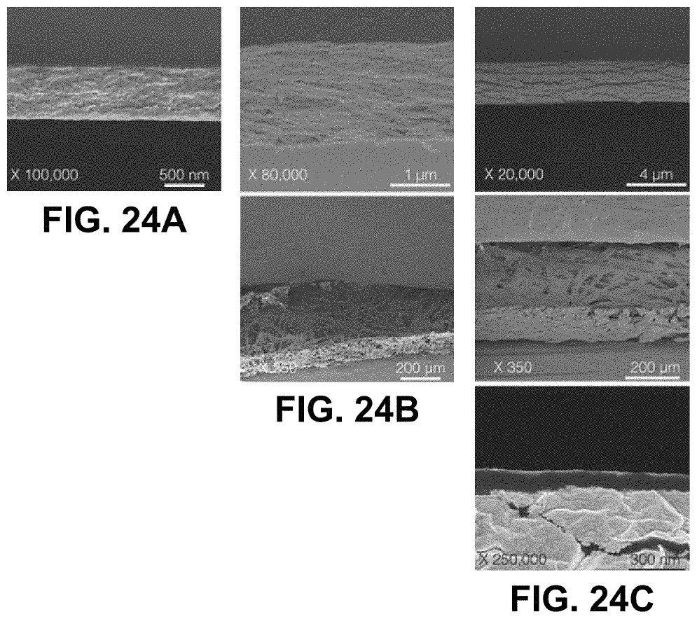

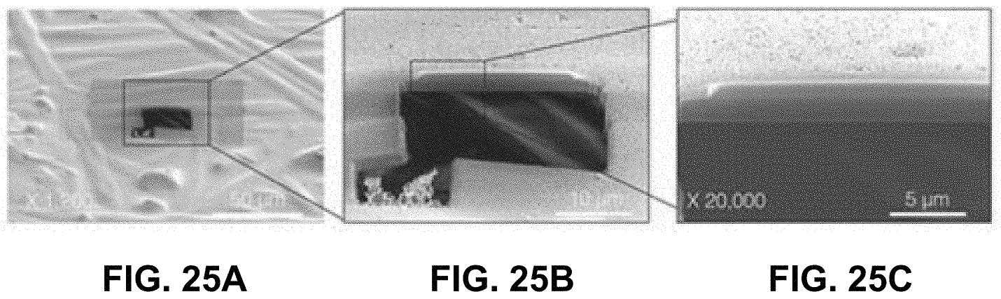

FIGS. 24A-24C present cross-section images of symmetric alginate membranes, column a shows an image of 1% alginate membranes with a thickness of approximately 700 nm. The morphology of these symmetric membranes as apparent was more like a layered dense structure. Column b showcases 3% alginate membranes crosslinked and then left to dry at about room temperature with an obvious increase in thickness to reach about 1.3 μm. Such membranes have a MWCO of about 1300 g/mol and a permeance of methanol of about 1 L/m²·hr·bar. To test the effect of the step following the crosslinking reaction, instead of leaving the membranes to dry at room temperature, the membranes were immersed in a non-solvent (in this case acetone) for a period of about 2 minutes and cross-sections of these membranes are shown in column c. These membranes have similar thickness and MWCO values of around 2 μm and 1300 g/mol respectively, however, the permeance tested was higher with an 8 time increase. The last image in column c shows a higher magnification of the symmetric alginate membrane and it was clear that there was a skin layer with dark color and a thickness of about 100 nm existed due to the non-solvent immersion. Focused ion beam images were also provided in FIGS. 25A-25C for the accurate estimation of thickness of the alginate membrane prepared with 3% concentration followed by crosslinking in 5% CaCl₂ for about 5 minutes then left to dry.

### Topography of Alginate Membranes

The surface topography of the alginate membranes on different supports is presented in FIGS. 20A-20C. The surface roughness was similar for alginate prepared on PAN and polyester, however, the alumina's sharp surface structure increased the roughness value for alginate membranes. FIGS. 18A-18B present the height mapping of alginate on PAN and polyester supports.

### Nanofiltration Performance

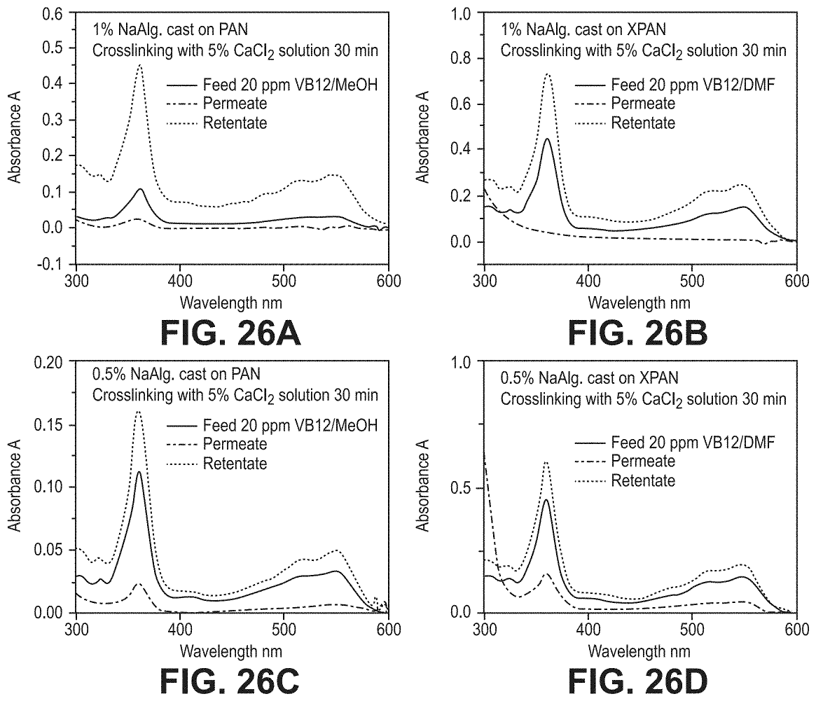

FIGS. 26A-26D show UV analysis of the feed, permeate, and retentate samples in methanol and DMF filtration containing B12. Filtrations were carried out at a pressure range of about 5-15 bar. Two types of alginate thin film composite membranes with two different concentrations were prepared on the PAN supports. Table 1 summarizes the permeances and rejections of the as-prepared NaAlg membranes. Different post treatment led to different membrane performance. Crosslinking rendered membranes with reasonable permeances and good rejections. For these membranes, coating with 1% NaAlg led to more than 98% rejection of B12 in methanol and DMF, while the rejection of the 0.5% membrane was slightly lower. Using 0.1% alginate concentration brought about defective membranes as indicated by the very low rejections. No decent rejections were obtained for the air-dried NaAlg membranes. Furthermore, the permeance of the acetone-precipitated membrane was very low, which was most likely due to the formation of skin dense layer and the fast solidification of membranes with collapsed pores. Using cellulose as a support (to provide green option) resulted in similar rejection to the value of the PAN supported membrane, while the lower permeance indicated the low porosity of the cellulose layer. For the experiments with DMF, other membranes were prepared on the more stable XPAN support. Similar rejections to the values of the PAN supported membranes were obtained in DMF, indicating the good stability of the support that maintained the alginate sieving performance in the harsh solvent. However, the permeance value was compromised by the denser support structure (due to crosslinking).

The mesoporous support layer of the thin film composite may impose very significant resistance to the solvent transport. To better estimate the membrane performance and minimize the effect of support resistance, freestanding membranes laid on top of a highly porous alumina disc (as seen in FIGS. 19A-19G) were prepared. As alumina support is excellently stable in any solvents, the freestanding membranes on alumina were tested using various solvents. Visual observation of the free-standing films soaked for about 3 days in solvents such as DMSO, DMF, NMP, and methanol confirmed the good stability of the films. A series of solvent permeances were tested using the same membrane are presented in supporting information FIG. 23, the water permeance was retained to similar value after harsh solvents were filtered.

The permeance of the alumina supported membranes as compared to the ones on PAN support was most likely expected to be much higher due to the porosity of the alumina as well as the absence of the pore penetration in the membrane surface pores, since the membrane preparation was independent on the support. However, the values obtained were very similar to the thin film composite membranes, which can only be attributed to the fact that these values represent the intrinsic permeances of the standalone alginate layer, meaning that even thin film composite membranes did not suffer from severe pore penetration.

Pure solvent permeances were obtained by the membranes supported by alumina and summarized in Table 2. Also rejection test was performed to identify the MWCO of free-standing membranes on alumina. Low permeances of solute/solvent were observed when compared to pure solvents. For instance, the permeance of methanol containing B12 was about 0.82 L/m²·h·bar, while pure methanol permeance was about 1.5 L/m²·h·bar. The most possible explanation for this rare finding was the phenomenon of membrane pore blockage by the solute molecules, hindering the solvent molecules to permeate freely through the membrane.

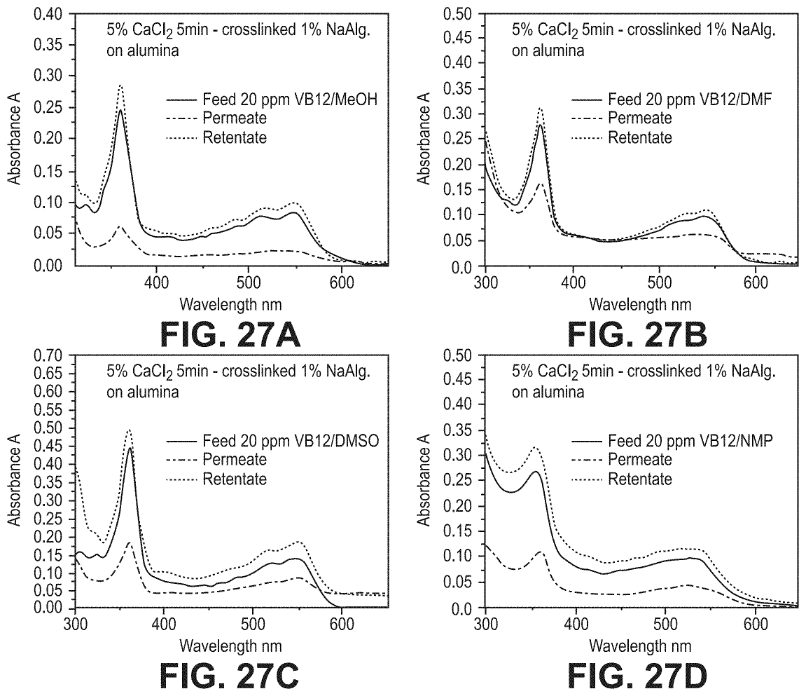

Table 2 summarizes the permeance and rejection values of the alumina supported membranes using B12 in different solvents (FIGS. 27A-27D present UV analysis). The highest permeance of about 0.82 L/m²·h·bar was achieved using methanol, followed by DMF, DMSO and NMP, respectively. About 70%, 76%, and 80% rejections were achieved with vitamin B12 in DMF, DMSO, and NMP, respectively. These plausible values proved that the alginate membranes had a good stability in the tested solvents. Better performance could be obtained through careful optimization of the initial polymer concentration, crosslinker concentration, and crosslinking time as well as better nanofilm handling.

In addition to PAN, cellulose and alumina support, alginate membranes by casting alginate solution directly on a non-woven polyester support were also prepared. The aim was to produce greener membranes by eliminating the mesoporous middle layers (such as PAN and cellulose) that are usually present in the normal thin film composites. It was expected to obtain higher permeance by lowering the resistance in the support. As this support possesses a highly coarse and porous structure, defect formation was prevented by using higher NaAlg concentration of about 3% in addition to about 1%, the crosslinking conditions were about 5% concentration for about 5 min.

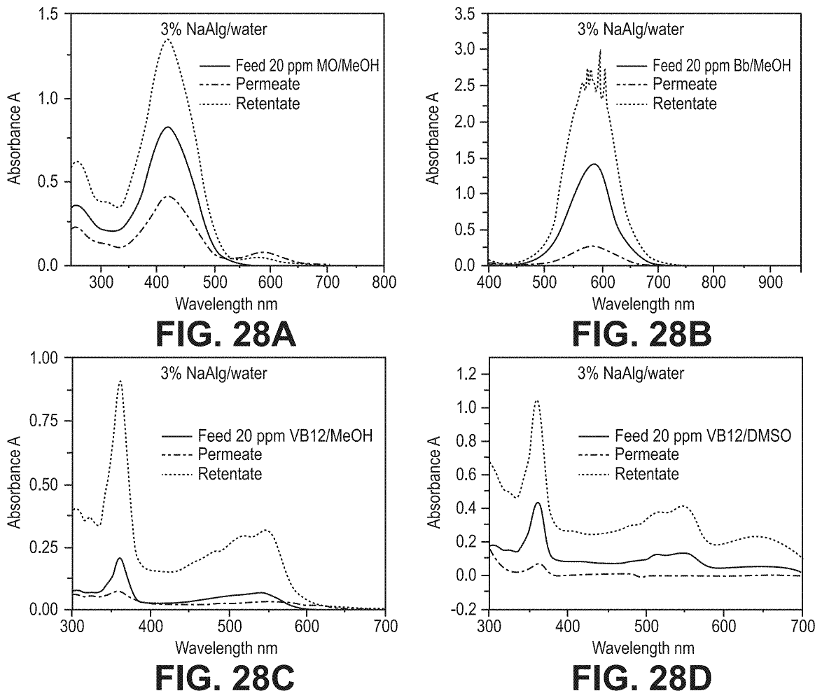

It can be seen from FIG. 21F that the 1% NaAlg resulted in defective membranes indicated by the zero B12 rejection. As expected, this was due to the highly rough surface of the polyester that created unwanted voids on the alginate layer. Fortunately, the B12 rejection of the cast 3% NaAlg membrane was between about 92-94% (FIGS. 28A-28D), comparable to rejections of the NaAlg membranes supported by PAN and alumina. This implied that all the resulting alginate structures were identical as they led to similar sieving performance. Significant differences can be expected in terms of permeance due to variation of the transport resistance in the support. By testing the 3% NaAlg membrane on polyester, about a 1,200 g/mol MWCO was revealed and can be considered as the intrinsic property of the crosslinked alginate membranes prepared in this Example. However, as the NaAlg concentration was higher than the concentration used in the PAN supported membranes, higher permeances were not obtained. The methanol permeances of this membrane configuration were around 1, 0.1 and 0.5 L/m²·hr·bar in methanol, DMSO, and water, respectively.

In summary, the utilization of alginate as a promising biopolymer membrane for OSN was reported. The membranes were prepared by depositing NaAlg on different supports, followed by the one step precipitation-crosslinking reaction using CaCl₂ aqueous solution at about room temperature. For both a porous polymeric and porous alumina support, the permeance and rejection values of alginate membranes were similar. The performance of alginate membranes described herein indicated the actual separation quality of the alginate film regardless of the support used or the method prepared which conveyed identical structure. The only determining factor was the membrane thickness, which resulted in different permeances. The thickness of each configuration was different due to the different factors like crosslinking time, alginate concentration, or method of film applying, such as casting or spin coating. For example, casting on a support resulted in similar performance to independently preparing a film and laminating it on alumina. Also, membranes prepared with 1% concentration on PAN showed a thickness of around 1.7 μm, however, 3% alginate membranes on polyester exhibited lower thickness of around 1.3 μm. The pure permeances of methanol, DMF, and DMSO of alginate on alumina were about 1.5, 0.77, and 0.8 L/m²·h·bar, respectively. The molecular weight cut off was about 1,200 g/mol tested on the cast alginate membrane on a non-woven polyester only if 3% alginate was used. Overall, this route offered the sustainable membrane fabrication for greener solvent separations.

TABLE 1
Performance of alginate composite membranes.

| NaAlg | | | MeOH | 20 ppm B12/MeOH | |
|---|---|---|---|---|---|
| concentration | | | Permeance | Permeance | Rejection |
| (%) | Support | Post treatment | (L/m² · h · bar) | (L/m² · h · bar) | (%) |
| 1 | PAN | Crosslinking 5% CaCl₂, 30 min | 1.4 ± 0.2 | 1.27 ± 0.2 | 98 ± 2 |
| 0.5 | PAN | Crosslinking 5% CaCl₂, 30 min | 2.1 ± 0.1 | 1.46 ± 0.3 | 85 ± 3 |
| 0.1 | PAN | Crosslinking 5% CaCl₂, 30 min | | 22.93 ± 5 | 34 ± 2 |
| 1 | Cellulose | Crosslinking 5% CaCl₂, 30 min | | 0.38 ± 0.1 | 95 ± 1 |
| 1 | PAN | Drying at room temperature | | ND | — |
| 0.5 | PAN | Drying at room temperature | 20 ± 2 | 17.19 ± 2 | 30 ± 3 |
| 0.1 | PAN | Drying at room temperature | | 33.44 ± 4 | 0 |
| 0.5 | PAN | Precipitation in acetone | | 0.08 ± 0.02 | 91 ± 1 |

| | | | 20 ppm Permeance B12/DMF | |
|---|---|---|---|---|
| | | | (L/m² · h · bar) | Rejection (%) |
| 1 | XPAN | Crosslinking 5% CaCl₂, 30 min | 0.21 ± 0.1 | 98 ± 1 |
| 0.5 | XPAN | Crosslinking 5% CaCl₂, 30 min | 0.85 ± 0.3 | 80 ± 3 |

ND: not detected.

TABLE 2
Permeance and B12 rejection values of the membranes prepared from 1%
NaAlg crosslinked with 5% CaCl₂ for 5 min on alumina support.

| | Pure Permeance | Mixture Permeance | Rejection |
|---|---|---|---|
| Solvent | (L/m² · h · bar) | (L/m² · h · bar) | (%) |
| MeOH | 1.8 ± 0.2 | 1.6 ± 0.1 | 90 ± 2 |
| DMF | 0.77 ± 0.1 | 0.25 ± 0.02 | 70 ± 1 |
| DMSO | 0.8 ± 0.1 | 0.15 ± 0.05 | 76 ± 2 |
| NMP | 0.9 ± 0.05 | 0.11 ± 0.03 | 80 ± 3 |

TABLE 3
Permeance and rejection values of dyes in methanol, DMCO and water
tested through free-standing alginate membranes on polyester.

| Membrane Type (crosslinked alginate | 20 ppm Dye/Methanol | Permeance | Rejection |
|---|---|---|---|
| on non-woven 5% CaCl2 5 min) | (MW g/mol) | (L/m² · h · bar) | (%) |
| 3% crosslinked alginate | Methyl orange (327) | 0.96 ± 0.2 | 67 ± 3 |
| | Brilliant blue (825) | 1.14 ± 0.02 | 85 ± 2 |
| 1% crosslinked alginate | VB12 (1355) | 1.06 ± 0.05 | 92 ± 1 |
| | VB12 (1355) | 794 ± 10 | 0 |

20 ppm Dye/DMSO (MW g/mol)

| | | | |
|---|---|---|---|
| 3% crosslinked alginate | VB12 (1355) | 0.13 ± 0.03 | 94 ± 1 |

0.2% PEG (MWg/mol)/water

| | | | |
|---|---|---|---|
| 3% crosslinked alginate | (600, 3K, 10K, 35K) | 0.45 ± 0.01 | 86 ± 2 |
| | | | (600 g/mol) |

### EXAMPLE 2

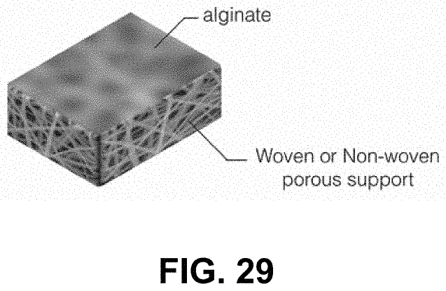

In this Example, thin-film composite membranes for nanofiltration are introduced, particularly for solutes dissolved in water or organic solvents. This Example also introduces manufacturing methods, among other things. The membranes include two distinctive layers: an alginate layer on top of a highly porous woven or non-woven support. The dense thin top layer was composed of alginate polymer crosslinked with divalent salts while the bottom layer consisted of a porous structure (FIG. 29).

The dense top layer was formed by immersing a viscous alginate solution film, which was cast on a support, to a water bath containing small amounts of a divalent salt that crosslinked the alginate chains. Immediately after the contact, the viscous film was transformed into a gel film formed at the surface of the support. This newly formed gel layer made of crosslinked alginate chains was insoluble due to the high degree of crosslinking. The last step was the drying step to convert the gel film into solid; the drying method included either room temperature drying or solvent exchange by immersion in a non-solvent. These membranes were strong candidates for filtration in organic solvents. The advantages of these membranes include, but are not limited to, the following: (i) the alginate polymer is cheap and abundant; (ii) the solution formation is facile and energy-efficient; preparation is at room temperature using green solvent (water); (iii) low concentration of alginate is sufficient to form a continuous defect-free layer with good separation properties; and (iv) the crosslinking is also energy-efficient; it takes place in water at room temperature using non-harmful substances. The resulting membranes were highly stable in numerous solvents.

Organic solvent nanofiltration (OSN) is a recent technology where aqueous-nanofiltration membranes are modified to withstand harsh solvents. These membranes allow size-exclusion based separation of solutes in the range of 200-2000 g/mol. Processes such as solvent recovery, solvent exchange concentration or purification all in organic media are examples of potential applications. Although OSN is considered as a green technology compared to conventional separation methods such as evaporation or crystallization, still the amount of toxic solvents used for the preparation, the energy requirement for heating as well as the chemical crosslinking reaction, and the solvent wastage combine to result in a heavy environmental burden on this technology.

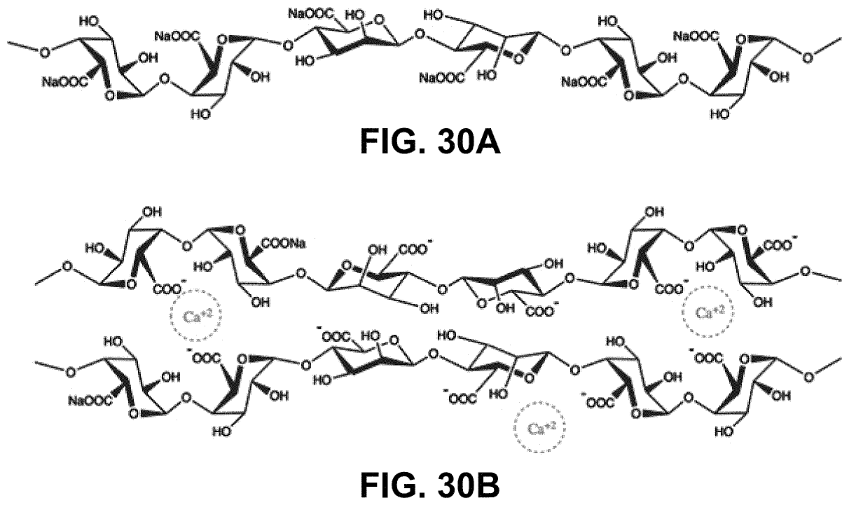

In this Example, a biopolymer was used, which is environmentally friendly, degradable, and abundant, for the facile fabrication of thin film composite membranes to be used in OSN, as well as pervaporation. FIGS. 30A-30B show the chemical structure of the alginate polymer (a) and the crosslinked structure (b). Forming this film directly on a non-woven not only made the process easier and cheaper, but also the chemical stability of the resulting membranes was high and no post chemical treatment was needed. In this process, the alginate film was precipitated in a water bath containing a divalent salt as crosslinker. This crosslinking reaction transformed the film into a solvent-resistant dense layer that did not dissolve in its original solvent.

This process may use a biopolymer with functional groups that can be crosslinked very fast (within seconds), preferably at about room temperature, and a crosslinker that was soluble in the same solvent as the polymer solution or any solvent that dissolved the polymer (good solvent) in order to assure that the phase separation in the first bath was promoted by the crosslinking reaction.

The three general steps of the alginate thin film membranes are depicted in FIG. 3: (i) casting a thin film of the alginate solution on a non-woven; (ii) immersing the alginate film in a bath of water (good solvent for the alginate) containing a certain concentration of crosslinker, wherein crosslinking and precipitation occur in the same step; and (iii) drying the resulting film by any means such as solvent exchange or room temperature drying.

Some of the parameters during membrane fabrication affected the overall performance of the membrane including, but limited to, the alginate concentration, where the concentration of the alginate control the thickness of the membrane; the crosslinker concentration, where the concentration of the divalent salt controlled the selectivity of the membrane, where high concentrations led to denser membranes; immersion time in the crosslinker/precipitation bath, where the degree of crosslinking was highly affected by the duration of the crosslinking reaction; and choice of the crosslinker, where the choice of the divalent salt controlled the rate of the reaction, where higher reactivity led to denser membranes with higher thicknesses.

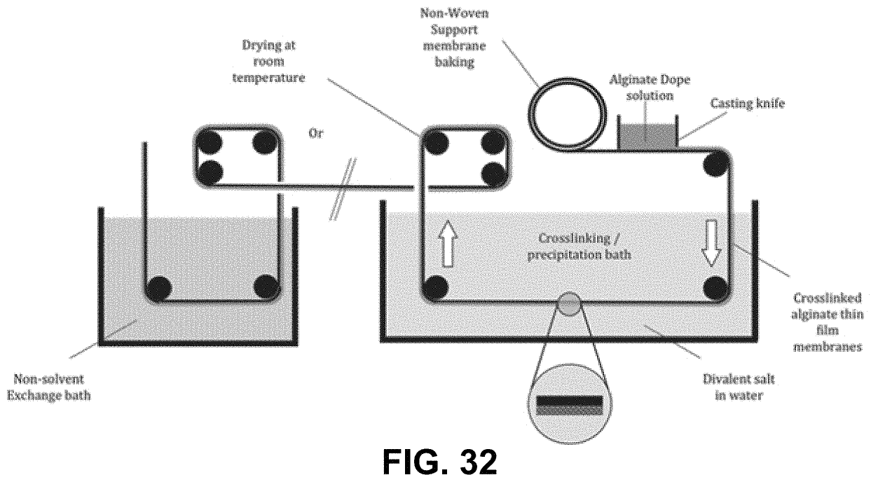

The manufacturing process proposed in this invention includes continuous casting machine with casting knife of adjustable thickness; immersing the cast film into a crosslinking/precipitation bath consisting of a divalent aqueous salt solution, wherein the time of immersion (time of crosslinking reaction) is controlled by the casting speed; and removing solvent, wherein the membranes may, for example, be left to dry at about room temperature or immersed into a non-solvent with high volatility. FIG. 32 represents the continues casting procedure.

### Thickness Variation by Changing Alginate Concentration

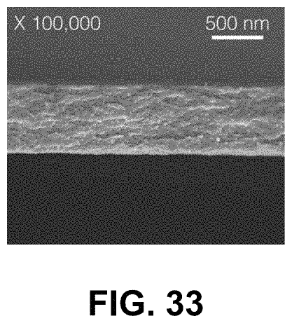

1% sodium alginate was dissolved in water at about room temperature under stirring for about 3 hours. After obtaining a bubble free solution, a casting knife of about 150 1.tm was used to cast a film of the alginate solution on a non-woven support. About 5% calcium chloride (CaCl₂) salt was dissolved in water and used as a crosslinker/precipitation bath. The membranes were immersed in this bath for about 5 min. Following the crosslinking/precipitation step, a drying step at about room temperature was performed. FIG. 33 shows a cross-section SEM image of the discussed membrane; a thickness of 700 nm was achieved.

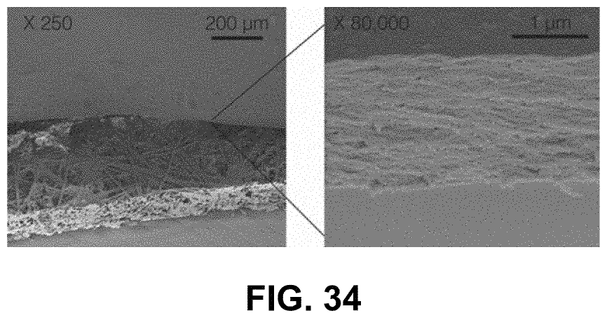

3% sodium alginate was dissolved in water at about room temperature under stirring for about 3 hours. After obtaining a bubble free solution, a casting knife of about 150 μm was used to cast a film of alginate solution on a non-woven support. About 5% calcium chloride (CaCl₂) salt was dissolved in water and used as a crosslinker/precipitation bath. The membranes were immersed in this bath for about 5 min. Following the crosslinking/precipitation step a drying step at about room temperature was performed. FIG. 34 shows a cross-section SEM image of the discussed membrane; a thickness of 1.2 μm was achieved.

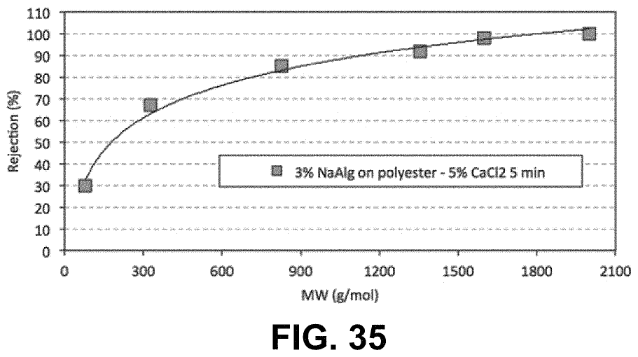

The water permeance of these membranes was measured, and the rejection for Brilliant Blue was determined. The 1% alginate membranes had a water flux of about 700±10 L/m²·hr·bar at about 4 bar while the 3% membranes had a flux of about 25±5 L/m²·hr·bar at about 2 bar. Both membranes have been crosslinked in about 5% CaCL₂ for about 5 min followed by drying at about room temperature. 95% rejection of 0.0005% brilliant Blue dye (about 825 g/mol) in water was achieved with the 3% alginate membranes, while the 1% alginate membranes were not efficient for this rejection. Testing about 0.2% PEG (600, 3K, 10K, 35K) g/mol in water for the 3% alginate membranes revealed that the MWCO is about 750 g/mol, FIG. 35.

### Performance of 3% Alginate Thin Film Composite Membranes on Non-Woven Polyester for Solvent Filtration

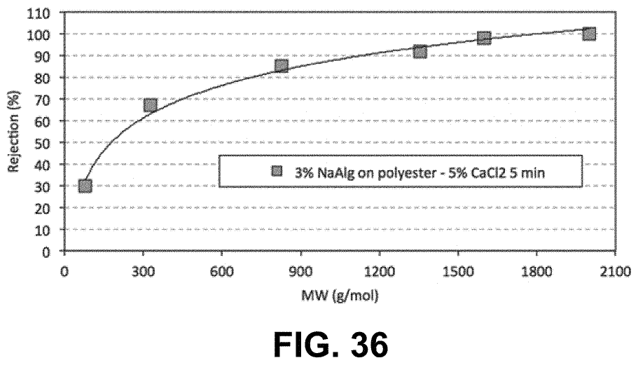

3% alginate thin film composite membranes prepared on non-woven polyester was tested with different dyes in methanol, the results were around 67% rejection of Methyl orange (about 327 g/mol) with a permeance of about 0.96±0.2 L/m²·hr·bar, about 85% rejection of Brilliant blue with a permeance of about 1.14±0.02 L/m²·hr·bar and about 92% for Vitamin B12 (1355 g/mol) with a permeance of about 1.06±0.05 L/m²·hr·bar. FIG. 36 show that the MWCO of these membranes in methanol is about 1200 g/mol.

The performance for these membranes was also tested for harsh solvents such as DMSO and about 94% rejection of Vitamin B12 was achieved with a permeance of about 0.13±0.03 L/m²·hr·bar.

A process of manufacture for thin film composite membranes and their use in organic solvent filtration, these membranes comprised of (a) porous non-woven support and (b) a crosslinked alginate thin layer; wherein the non-woven is preferred to be hydrophobic in nature; [symbol] the crosslinked alginate thin layer is a hydrogel network with a structure formed by crosslinking reaction occurring between alginate cast film on non-woven support and salt water solution; the alginate dope solution containing a certain percent of alginate such as sodium alginate or potassium alginate while the crosslinking salt water solution containing a certain percent of divalent metal ions such as calcium chloride or magnesium chloride; the thin film of alginate solution is cast on non-woven for certain thickness by continuous casting machine then immersed in a coagulation bath containing salt water solution for a certain time controlled by the casting speed; crosslinking between the alginate and the divalent metal ions in the salt water solution occurs on the surface of the non-woven and provoke phase inversion where the alginate solution becomes a gel, the alginate membrane is obtained after drying of the water either by drying at room temperature or by solvent exchange. The crosslinked membranes are stable in all solvents.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of making a thin-film composite membrane, comprising:
casting a sodium alginate solution or potassium alginate solution on a porous woven or non-woven support;
immersing in an aqueous solvent containing one or more divalent salt; and
removing the solvent by drying at room temperature or immersing in a non-solvent suitable for solvent exchange;
wherein the immersing in the aqueous solvent containing one or more divalent salt induces a crosslinking reaction that transforms the alginate solution into an insoluble gel of crosslinked alginate membrane; and wherein the crosslinking reaction promotes phase separation in forming the membrane by reaction induced phase inversion.

2. The method of claim 1, wherein a concentration of sodium alginate or potassium alginate in the solution ranges from 0.5% to 5% by weight.

3. The method of claim 1, wherein the porous support includes one or more of polyacrylonitrile, crosslinked polyacrylonitrile, non-woven polyester, cellulose, alumina, silica, and glass.

4. The method of claim 1, wherein the porous support is hydrophobic.

5. (canceled)

6. The method of claim 1, wherein duration of the immersing in an aqueous solvent containing one or more divalent salt ranges from 30 seconds to 30 minutes.

7. The method of claim 1, wherein the divalent salt includes one or more of calcium chloride and magnesium chloride.

8. The method of claim 1, wherein a concentration of the divalent salt ranges from 0.5% to 10% by weight.

9. (canceled)

10. The method of claim 1, wherein the crosslinked alginate membrane has a thickness ranging from 0.7 μm to 2 μm.

11. A method of manufacturing membranes, comprising:
casting an alginate solution on a non-woven support feed using a casting knife;
immersing the solution-casted non-woven support feed in an aqueous solvent containing a crosslinking agent; and
removing the solvent by drying at room temperature or immersing in a non-solvent exchange bath.

12. The method of claim 11, wherein the casting knife has a height that is adjustable to vary thickness of the alginate solution.

13. The method of claim 11, wherein the non-woven support feed is continuously fed to a reservoir comprising the alginate solution.

14. The method of claim 11, wherein duration of the immersing of the non-woven support feed is controlled by the casting speed of the non-woven support feed.

15. The method of claim 11, wherein the crosslinking agent is a divalent salt.

16. A method of separating chemical species, comprising:
contacting a first side of a membrane prepared according to the method of claim 1 with a feed stream containing one or more chemical species dissolved in water or organic solvent;
separating one or more chemical species by organic solvent nanofiltration or pervaporation; and
collecting the separated chemical species as permeate from a second side of the membrane.

17. The method of claim 16, wherein the membrane has a molecular weight cut off ranging from 500 g/mol to 1,200 g/mol.

18. The method of claim 16, wherein the organic solvent includes one or more of dimethyl sulfoxide (DMSO), dimethylformamide (DMF), tetrahydrofuran (THF), methanol, ethanol, toluene, n-methyl 2-pyrrolidone (NMP), and acetone.

19. The method of claim 16, wherein the separating is based on organic solvent nanofiltration and includes collecting the permeate from the second side of the membrane.

20. The method of claim 16, wherein the separating is based on pervaporation and includes collecting the permeate in a vapor or gas phase from the second side of the membrane.

21. The method of claim 1, wherein the divalent salt comprises magnesium chloride.

22. The method of claim 1, wherein the crosslinked alginate membrane has a thickness ranging from 0.05 μm to 5 μm.
